(19) United States
(12) Patent Application Publication
(10) Pub. No.: US 2002/0062379 A1
(43) Pub. Date: May 23, 2002

(54) Method and apparatus for coordinating quality of service requirements for media flows in a multimedia session with IP bearer services

(76) Inventors: Ina B. Widegren, Stockholm (SE); Johnson Oyama, Solna (SE); Thian J. Tan, Victoria (AU); Brian C. Williams, Victoria Georges (AU)

Correspondence Address: NIXON & VANDERHYE P.C., 8th Floor, 1100 North Glebe Road, Arlington, VA, 22201, US

(21) Appl. No.: 09/985,631

(22) Filed: Nov. 5, 2001

Related U.S. Application Data
(60) Provisional application No. 60/275,354, filed on Mar. 13, 2001.
(60) Provisional application No. 60/273,678, filed on Mar. 6, 2001.
(60) Provisional application No. 60/269,573, filed on Feb. 16, 2001.
(60) Provisional application No. 60/269,789, filed on Feb. 16, 2001.
(60) Provisional application No. 60/269,572, filed on Feb. 16, 2001.
(60) Provisional application No. 60/267,737, filed on Feb. 9, 2001.
(60) Provisional application No. 60/260,766, filed on Jan. 10, 2001.
(60) Provisional application No. 60/260,765, filed on Jan. 10, 2001.
(60) Provisional application No. 60/246,501, filed on Nov. 6, 2000.
(60) Provisional application No. 60/248,110, filed on Nov. 13, 2000.
(60) Provisional application No. 60/324,523, filed on Sep. 26, 2001.

(51) Int. Cl. G06F 15/16

(52) U.S. Cl. 709/227

(57) ABSTRACT

To set up a multimedia session involving a mobile terminal, a session packet access bearer is established between the mobile terminal and an access point to a packet data network by way of a radio access network. The access point is coupled to a multimedia system that provides multimedia session services. Using the session packet access bearer, a multimedia session involving the mobile terminal is initiated that includes a plurality of media data streams. Media packet access bearers between the mobile terminal and the access point are established. Media binding information is used to associate that multimedia session and each media data stream to one of the media packet access bearers used to transport a corresponding one of the media data streams between the mobile terminal and the access point. The media binding information may be used in a variety of ways to set up and control the multimedia session and the media packet access bearers.

### CROSS-REFERENCE TO RELATED APPLICATIONS

This application is related to commonly-assigned U.S. patent application Ser. No. 09/768,956, entitled “RSVP Handling in 3G Networks,” filed on Jan. 24, 2001; U.S. patent application Ser. No. 09/861,817, entitled “Application Influenced Policy,” filed on May 21, 2001; U.S. patent application Ser. No. ______, entitled “Media Binding to Coordinating Quality of Service Requirements for Media Flows in a Multimedia Session with IP Bearer Resources,” filed Nov. 5, 2001; and U.S. patent application Ser. No. ______, entitled “Method and Apparatus for Coordinating Charges for Services Provided in a Multimedia Session,” filed Nov. 5, 2001, the disclosures of which are incorporated herein by reference.

### REFERENCE TO PRIORITY APPLICATIONS

This application claims priority from and incorporates by reference the following commonly-assigned provisional patent applications: 60/275,354 entitled “Enhancement of Authorization Token for RSVP Interworking,” filed Mar. 13, 2001; 60/273,678 entitled “SDP Support for QoS Based SIP Sessions,” filed Mar. 6, 2001; 60/269,573 entitled “QoS Characteristics for a UMTS Bearer Appropriate for IP Signaling,” filed Feb. 16, 2001; 60/269,789 entitled “Architecture for Packet Data Protocol Context Suitable for Signaling,” filed Feb. 16, 2001; 60/269,572 entitled “Binding a Signaling Bearer for Use With an IP Multimedia Subsystem,” filed Feb. 16, 2001; 60/267,737 entitled “Authorization Token in PDP Context Activation/Modification in Bearer Establishment for SIP Call Setup (Qos),” filed Feb. 9, 2001; 60/260,766 entitled “QoS Pre-Condition Met,” filed Jan. 10, 2001; 60/260,765 entitled “IP Specific Elements in PDP Context Activation/Modification,” filed Jan. 10, 2001; 60/246,501 entitled “Principle of User Choice,” filed Nov. 6, 2000; 60/248,110 entitled “Triggering RSVP Host,” filed Nov. 13, 2000; and 60/324,523, entitled “Use of GPRS APN in IMS/Ipv6 Context,” filed on Sep. 26, 2001.

### FIELD OF THE INVENTION

The present invention generally relates to Internet Protocol (IP) networks, and more specifically, to coordinating Quality of Service (QoS) provisioning mechanisms in IP networks with multimedia applications.

### BACKGROUND

IP networks were originally designed to carry “best effort” traffic where the network makes a “best attempt” to deliver a user packet, but does not guarantee that a user packet will arrive at the destination. Because of the market success of IP networks, there is a clear requirement for mechanisms that allow IP networks to support various types of applications. Some of these applications have Quality of Service (QoS) requirements other than “best effort” service. Examples of such applications include various real time applications (IP Telephony, video conferencing), streaming services (audio or video), or high quality data services (browsing with bounded download delays). Recognizing these QoS requirements, the Internet Engineering Task Force (IETF), which is the main standards body for IP networking, standardized a set of protocols and mechanisms that enable IP network operators to build QoS-enabled IP networks.

FIG. 1 depicts a simplified high-level model of an IP network which may be useful in explaining QoS provisioning. As can be appreciated, the model includes two users, but could easily be expanded to include more users without changing the basic functionality of the network. In FIG. 1, User-A 101 may communicate with User-B 102 or with an application server 103. For example, in the case of an IP telephony session, User-A 101 may communicate with User-B 102. Similarly, in the case of streaming services, User-A 101 may communicate with the application server 103, which may be configured as a video server. In either case, User-A 101 accesses an IP backbone network 104 through a local access network 105, such as PSTN (dial-in access), Global System for Mobile Communications (GSM), or Universal Mobile Telecommunications System (UMTS) network. User-B 102 is similarly connected to the IP network 104 through a local access network 106. It will be appreciated that User-A and User-B need not use the same type of access network. The IP network 104 may consist of a number of IP routers and interconnecting links that together provide connectivity between the IP network's ingress and egress points and thereby make two party communication possible. As far as the users are concerned, the perceived QoS depends on the mechanisms both in the access networks 105, 106 and on the IP backbone network 104. Of particular interest to this invention is the specific case where at least one of the access networks is a UMTS or GSM/GPRS network.

When users access IP based services, they typically use a device that runs an application program that provides the interface for the user to access the particular service. For instance, in FIG. 1, User-A may use a laptop running a conferencing application program to attend an IP network based meeting, where participants of the meeting collaborate using various programs. Such programs are well known in the art.

Various user applications may access network services through an application programming interface (API). An API provides application programmers with a uniform interface to access underlying system resources. For instance, an API may be used to configure a network resource manager to require that a particular IP packet originating from a given application receive a certain treatment from the network, such as a particular QoS. For example, if the IP network is a Differentiated Services IP network, then an application program may request that all of its IP packets receive the “Expedited Forwarding” treatment.

The User (and the API in the user's equipment) may not be aware of the different technologies that various access networks and IP backbone networks employ in order to provide QoS end-to-end, i.e., from User-A all the way to remote User-B. For instance, the application program may use an RSVP/IntServ based API, and the end-to-end embodiment in which he is involved may include a UMTS access network and a non-RSVP enabled IP network. In such cases, some “interworking” mechanisms between such different technologies and protocols are needed to make sure that the QoS is provided end-to-end.

Integrated Services (IntServ) provides a set of well-defined services which enables an application to choose among multiple, controlled levels of delivery service for their data packets. To support this capability, two things are required. First, individual network elements, such as subnets and IP routers, along the path followed by an application's data packets must support mechanisms to control the quality of service delivered to those packets. Second, a way to communicate the application's requirements to network elements along the path and to convey QoS management information between network elements and the application must be provided.

IntServ defines a number of services such as Controlled-Load (defined in IETF RFC 2211) and Guaranteed (defined in IETF RFC 2212). The service definition defines the required characteristics of the network equipment in order to deliver the service. The individual network elements (subnets and IP routers) that support the service must comply with the definitions defined for the service.

The service definition also defines the information that must be provided across the network in order to establish the service. This function may be provided in a number of ways, but it is frequently implemented by the resource reservation setup protocol RSVP (defined in IETF RFC 2205). RSVP (Resource reSerVation Protocol) is an IP-level resource reservation setup protocol designed for an IntServ-enabled Internet (defined in IETF RFC 1633, 2205, and 2210). The RSVP protocol is used by a host (e.g., User A's computer) to request specific service from the network for particular application data streams or flows. RSVP is also used by routers to deliver quality-of-service requests to all nodes along the path(s) of the flows and to establish and maintain the state(s) to provide the requested service. RSVP requests generally result in resources being reserved in each node along the data path.

FIG. 2 shows an End-to-End Integrated Service between the hosts. The service is provided using routers and hosts that support the service definition defined for the required service and through signaling of the relevant information between the nodes. Since RSVP is a protocol that is primarily designed to be end-to-end, extra functionality is required in a situation where the RSVP sender would like to use it for resource reservation only in some portion of the end-to-end path. This situation may arise if RSVP is used in an access network and over-provisioning is used in the backbone network. In such situations, an RSVP (Receiver) Proxy is useful.

A Proxy is a network device, such as a router or a switch, that performs one or more functions on behalf of another device. An RSVP Proxy originates the RSVP RESV message in response to an incoming PATH message on behalf of the receiver(s) identified by the PATH message. (RESV and PATH are well known messages used in RSVP.) In other words, the RSVP (Receiver) Proxy acts on behalf of the remote host and thereby facilitates resource reservation between the originating host and the RSVP Proxy without the host needing to be involved in RSVP signaling. This is shown in FIG. 3. The RSVP Proxy may use knowledge of network conditions between the RSVP Proxy and the non-RSVP host.

Differentiated Services (DiffServ) enhancements to the Internet protocol are intended to enable scalable service discrimination in the Internet without the need for per-flow state and signaling at every hop. A variety of services may be built from a small, well-defined set of building blocks which are deployed in network nodes. The services may be either end-to-end or intra-domain; they include both those that can satisfy quantitative performance requirements (e.g., peak bandwidth) and those based on relative performance (e.g., “class” differentiation). Services may be constructed by a combination of setting bits in an IP header field at network boundaries (autonomous system boundaries, internal administrative boundaries, or hosts), using those bits to determine how packets are forwarded by the nodes inside the network, and conditioning the marked packets at network boundaries in accordance with the requirements or rules of each service.

Differentiated Services defines an edge router at the network boundary, and core routers within the network. The edge and core routers have different duties. The edge router must condition the traffic to ensure that it conforms to the service agreement. It also marks the traffic with the appropriate DSCP (Differentiated Services Code Point). It then forwards the packet according to the service behavior defined for that DSCP. The service behavior, called the Per Hop Behavior (PHB) may define the prioritization or weighting of that traffic to give it better service than other traffic. The core nodes examine the DSCP and apply the service behavior appropriate for that service. FIG. 4 shows an end-to-end service. The DS edge routers perform the traffic conditioning, while the DS core routers simply apply the PHB.

Services may be constructed by a unique combination of PHB and traffic conditioning. For example, two different services can be created using the same PHB by applying a different traffic conditioning functioning at the edge routers.

The IntServ architecture provides a means for the delivery of end-to-end QoS to applications over heterogeneous networks. To support this end-to-end model, the IntServ architecture must be supported over a wide variety of different types of network elements. In this context, a network that supports Differentiated Services may be viewed as a network element in the total end-to-end path.

From the perspective of IntServ, DiffServ regions of the network are treated as virtual links connecting IntServ capable routers or hosts (much as an ethernet LAN can be treated as a virtual link). Within the DiffServ regions of the network, routers implement specific PHBs (aggregate traffic control). The total amount of traffic admitted into the DiffServ region that will receive a certain PHB is controlled by the conditioning at the edge routers. An IntServ service can be provided across a DiffServ domain by applying admission control and traffic conditioning at the edge router to meet the IntServ Service specification, and signaling the RSVP service characteristics of the DiffServ domain to the next RSVP-enabled router. The information provided in the RSVP signaling should be appropriate for the service across the DiffServ domain. This is shown in FIG. 5.

To realize a QoS Service with clearly defined characteristics and functionality, a QoS bearer must be set up from the source to the destination of the service. A bearer is a logical connection between two entities through one or more interfaces, networks, gateways, etc., and usually corresponds to a data stream. A QoS bearer service includes all aspects to enable the provision of a contracted QoS. These aspects are among others the control signaling, user plane transport, and QoS management functionality.

Mobile Radio Access Data Networks, like General Packet Radio Service (GPRS) and Universal Mobile Telecommunication System (UMTS), may form a part of the overall network and will typically be a significant factor in the end-to-end bearer service for customers connected to it. Hence, the bearer service provided over a GPRS/UMTS network must provide the required end-to-end bearer service.

The GPRS/UMTS network includes a set of network elements between the host, referred to as the Mobile Station (MS), and an external packet switching network the user is connecting to like the Internet. These network elements are shown in FIG. 6. The radio access network (RAN) provides access over the radio interface to/from the MS. The RAN is coupled to a supporting gateway Gateway GPRS Support Node (SGSN) and a Gateway GPRS Support Node (GGSN). The GGSN provides the interworking with external packet-switched networks.

Before a mobile host can send packet data to an external host, the mobile host must “attach” to the GPRS network to make its presence known and to create a packet data protocol (PDP) context to establish a relationship with a GGSN towards the external network that the mobile host is accessing. The PDP attach procedure is carried out between the mobile host and the SGSN to establish a logical link. As a result, a temporary logical link identity is assigned to the mobile host. A PDP context is established between the mobile host and a GGSN selected based on the name of the external network to be reached. One or more application flows (sometimes called “routing contexts”) may be established over a single PDP context through negotiations with the GGSN. Again, an application flow corresponds to a stream of data packets distinguishable as being associated with a particular host application. An example application flow is in an electronic mail message from the mobile host to a fixed terminal. Another example application flow is a link to a particular Internet Service Provider (ISP) to download a graphics file from a website. Both of these application flows are associated with the same mobile host and the same PDP context. User data is transferred transparently between the MS and the external data networks with a method known as encapsulation and tunneling: data packets are equipped with PS-specific protocol information and transferred between the MS and the GGSN.

Quality of Service (QoS) has an extremely important and central role in 3^{rd} generation (3G) UMTS mobile networks. QoS is a means for providing end users with satisfying service. QoS also enables efficient use of the spectrum resources. Because the invention will be described in terms of a UMTS QoS architecture, a brief overview of QoS in UMTS is provided. The 3G UMTS QoS architecture is described, including an explanation of the packet data protocol context (PDP context), a traffic flow template (TFT), and the QoS maintenance procedures for activated UMTS bearers. It is expected that the QoS characteristics associated with a radio communication are the most critical in the end-to-end chain. Within UMTS access networks, the radio network resources are managed on a per PDP context level, which corresponds to one or more user flow/data streams and a certain QoS level.

The QoS framework for 3G networks is specified in the 3G specification (3GPP) TS23.107. The main focus is on the QoS architecture to be used in the UMTS level, where the list of QoS attributes applicable to UMTS Bearer Service and the Radio Access Bearer Service are specified along with appropriate mapping rules. TS23.060 specifies the general mechanisms used by data packet connectivity services in the UMTS level, which includes the General Packet Radio Service (GPRS) in GSM and UMTS.

In a UMTS QoS Architecture, a network service is considered to be end-to-end, from a Terminal Equipment (TE) to another TE. To realize a certain end-to-end QoS, a bearer service with clearly defined characteristics and functionality is set up from the source to the destination of a service. Again, the bearer service includes those aspects needed to enable the provision of a contracted QoS, e.g., control signaling, user plane transport, QoS management and functionality.

A UMTS bearer service layered architecture is depicted in FIG. 7. Each bearer service on a specific layer offers its individual services using services provided by the layers below. Bearers at one layer are broken down into underlying bearers, each one providing a QoS realized independently of the other bearers. Service agreements are made between network components, which are arranged horizontally in FIG. 7. The service agreements may be executed by one or more layers of service. For instance, the UMTS bearer service consists of a Radio Access Bearer (RAB) service and a Core Network (CN) bearer service. The RAB services is then divided into a radio bearer service and a Iu bearer service. The Iu interface is the interface between the radio access network and the core network.

The following are examples of the entities shown in FIG. 7. The terminal equipment (TE) may be a laptop and the mobile terminal (MT) may be a cellular radio handset. The UTRAN may be made up of a combination of radio base stations called Node B's and radio network controllers (RNCs). The Core Network (CN) Iu Edge Node may be a serving GPRS support node (SGSN), and the CN Gateway may be a gateway GPRS support node (GGSN).

The QoS management functions in UMTS are used to establish, modify and maintain a UMTS Bearer Service with a specific QoS, as defined by specific QoS attributes. The QoS management functions of all the UMTS entities ensure provision of the negotiated UMTS bearer service.

The UMTS architecture comprises four management functions in the control plane and four in the user plane. The four control plane management functions are shown in FIG. 8:

Bearer Service (BS) Manager sets UP, controls, and terminates the corresponding bearer service. Each BS manager also translates the attributes of its level to attributes of the underlying bearer service during service requests.

Translation function converts between external service signaling and internal service primitives including the translation of the service attributes, and is located in the MT and in the CN Gateway.

Admission/Capability control determines whether the network entity supports the specific requested service, and whether the required resources are available.

Subscription Control determines whether the user has the subscription for the bearer being requested.

The four user plane management functions are:

Classification function resides in the GGSN and in the MT. It assigns user data units (e.g. IP packets) received from the external bearer service from the remote terminal (or the local bearer service) from the local terminal to the appropriate UMTS bearer service according to the QoS requirements of each user data unit. This is where the traffic flow template (TFT) and packet filters are situated, as described below.

Mapping function marks each data unit with the specific QoS indication related to the bearer service to which it has been classified. For example, it adds different service code points to packets before putting them on the Iu or CN bearer.

Resource Manager distributes its resources between all bearer services that are requesting use of these resources. The resource manager at tempts to provide the QoS attributes required for each individual bearer service. An example of resource manager is a packet scheduler.

Traffic conditioner is a shaping and policing function which provides conformance of the user data traffic with the QoS attributes of the concerned UMTS bearer service. This resides in the GGSN an d in the MT as well as in the UTRAN.

The QoS management functions of the UMTS bearer service in the user plane are shown in FIG. 9. These functions together maintain the data transfer characteristics according to the commitments established by the UMTS bearer service control functions, expressed by the bearer service attributes. The user plane uses the QoS attributes. The relevant attributes are provided to the user plane management functions by the QoS management control functions.

Four different QoS classes standardized in UMTS are shown in FIG. 10. Data transport may be optimized for the corresponding type of application data or for a bearer service of a certain class. The main distinguishing factor between these classes is how delay sensitive the traffic is: Conversational class is meant for traffic which is very delay sensitive (for real-time services) while Background class is the most delay insensitive traffic class (for non-real time services). Bit error/packet loss rate is also a significant difference between the classes.

To characterize a bearer service in detail, a set of bearer service attributes are standardized in UMTS as shown in the tables referenced below. A certain QoS is requested by selecting a set of attribute values that describes the bearer requirement. Parameters differ depending on the type of bearer service requested. FIG. 11 shows which attributes that are applicable to which traffic class.

FIG. 12 provides an overview of uses for different QoS attributes. The exact definitions of the QoS attributes can be found in TS23.107. A subscription is associated with one or more Packet Data Protocol (PDP) addresses, i.e., IP addresses in the case of IP traffic. Each PDP address is described by one or more PDP contexts stored in the MS, the SGSN, and the GGSN. Default values are also available in the cellular system data base, e.g., the HLR, which holds the subscription information. Each PDP context may be associated with a Traffic Flow Template (TFT). At most, one PDP context (associated with the same PDP address) may exist at any time with no TFT assigned to it. The relationship between PDP address, PDP context, and TFT is provided in FIG. 13.

A PDP context is implemented as a dynamic table of data entries, comprising all needed information for transferring PDP PDUs between MS and GGSN, for example addressing information, flow control variables, QoS profile, charging information, etc. The relation between UMTS bearer services and PDP context is a one-to-one mapping, i.e., if two UMTS bearer services are established for one PDP address, two PDP contexts are defined. The PDP context procedures are standardized in TS23.060. The concepts surrounding the QoS profile and the Traffic Flow Template (TFT) are relevant from the QoS perspective.

The UMTS QoS attributes have been selected and defined mainly for supporting efficient radio realization. A QoS profile is defined by a set of UMTS QoS attributes. The RNC obtains the pertinent radio access bearer (RAB) QoS profile from the SGSN during PDP context activation. There are three different QoS profiles involved in a PDP context activation-the requested QoS profile, the negotiated QoS profile, and the subscribed QoS profile (or the default QoS profile).

A Traffic Flow Template (TFT) is a packet filter (or set of filters) that associates packets to the correct PDP context thereby ensuring that packets are forwarded with correct QoS characteristics. The TFT enables the possibility of having several PDP contexts with varying QoS profiles, associated to a single PDP address. The TFT is managed and initiated by the MT both for the uplink and downlink flows. The uplink TFT resides in the MT, while the downlink TFT resides in the GGSN. The downlink TFT is sent from the MT to the GGSN during PDP context activation/modification. The downlink TFT's may be added to a PDP context that was created without one, and the contents may be modified as well.

FIG. 14 shows TFT packet filter attributes and valid combinations. Each TFT has an identifier and an evaluation precedence index that is unique within all TFT's associated with the PDP contexts that share the same PDP address. The MS manages the identifiers and the evaluation precedence index of the TFT's, as well as the packet filter contents. Some of the attributes in FIG. 14 may coexist in a packet filter while others mutually exclude each other. Only those attributes marked with an “X” may be specified for a single packet filter. All the marked attributes may be specified, but at least one has to be specified.

The PDP context signaling carries the requested and negotiated QoS profile between the nodes in the UMTS network. It has a central role for QoS handling in terms of admission control, negotiation, and modifying of bearers on a QoS level. The PDP context signaling message exchanges are described below with reference to the numerals in FIG. 15.

1. An RRC connection establishment is performed. This procedure is needed for establishing a connection, but does not cover more from a QoS perspective than that the type of radio channel is roughly indicated.

2. The MS sends a PDP message, “Activate PDP context request,” to the SGSN. The requested QoS profile is included in this message. At this stage, the SGSN makes an admission check and might restrict the requested QoS if the system is overloaded.

3. The SGSN sends a RANAP message, “RAB Assignment Request,” to the RNC in the UTRAN. RANAP, or Radio Access Network Application Part, is an application protocol for supporting signaling and control transmission between the UTRAN and the external CN. RANAP permits communication between the UTRAN and circuit-switched or packet-switched networks. This request to establish a radio access bearer (RAB) service carries the (perhaps modified) RAB QoS attributes.

4. From the RAB QoS attributes, the RNC determines the radio-related parameters corresponding to the QoS profile, e.g., transport format set, transport format combination set, etc. In addition, the UTRAN performs an admission control on this bearer.

5. The RNC sends an RRC message, “Radio Bearer Set-up,” to the MS. The RRC message includes the radio-related parameters that were determined in step 4.

6. The UTRAN and the MS apply the radio parameters and are ready to transfer traffic. To signal this, the MS sends a “Radio Bearer Set-up Complete” RRC message to the RNC.

7. The UTRAN sends a “RAB Assignment Complete” RANAP message to the SGSN.

8. A Trace procedure may be initiated. This is an operation and maintenance function for surveying subscribers.

9. The SGSN sends a “Create PDP Context Request” to the GGSN carrying the QoS profile. However, the QoS profile may have different parameters than those requested by the MS in step 2. Based on this profile, an admission control is performed at the GGSN level, and the GGSN may restrict the QoS if, for example, the system is overloaded. The GGSN stores the PDP context in its databases.

10. The GGSN returns the negotiated QoS to the SGSN in a “Create PDP Context Response” message and the SGSN stores the PDP context in its database.

11. The negotiated QoS is sent from the SGSN to the MS in an “Activate PDP Context Accept” message. If either the SGSN or the GGSN has modified the QoS profile, then the MS has to either accept or reject this profile.

Several admission controls take place in the procedure. Because bandwidth associated with radio is the most expensive resource, the UTRAN is consulted in determining whether radio resources are available during PDP context activation or modification. In other words, admission control in UMTS is performed in a radio centric manner.

To provide IP QoS end-to-end, it is necessary to manage the QoS within each domain. An IP BS Manager in the Gateway is used to control the external IP bearer service. Due to the different techniques used within the IP network, this is communicated to the UMTS BS manager through the Translation function. There is a likewise a need for an IP bearer service manager function to be provided in UE, where the bearer service manager maps the QoS requirements of the application to the appropriate QoS mechanisms. FIG. 16 shows the embodiment for control of an IP service using IP BS Managers in both possible locations in the UE and Gateway node. FIG. 16 also indicates the optional communication path between the IP BS Managers in the UE and the Gateway node. The IP BS Managers use standard IP mechanisms to manage the IP bearer service. These mechanisms may be different from mechanisms used within the UMTS, and may have different parameters controlling the service. The translation/mapping function provides the interworking between the mechanisms and parameters used within the UMTS bearer service and those used within the IP bearer service, and interacts with the IP BS Manager. If an IP BS Manager exists both in the UE and the Gateway node, it is possible that these IP BS Managers communicate directly with each other by using relevant signaling protocols.

An IP Multimedia Service (“IMS”) may be defined “on top” of the GPRS bearer service to provide multimedia sessions to end users. The quality of service aspects of bearers supporting IP multimedia is specified in the 3GPP TS 23.207, and the IP multimedia specification is set forth in the 3GPP TS 23.228. The MS is based on IP application signaling, which in a preferred, example embodiment includes session initiation protocol (SIP) and session description protocol (SDP). SIP is a signaling protocol to establish sessions, and SDP is a text-based syntax to describe the session and includes, for example, the definition of each media stream in the session.

For multimedia sessions, it is important that network managers and services providers be able to monitor, control, and enforce the use of network resources and services based on “policies” derived from certain established criteria such as the identity/authority level of users and applications, traffic bandwidth requirements, security considerations, time of day/week, etc. Because there are varying circumstances in which various entities are entitled to use the services they request, there is a need for rules, a need for enforcement methods of these rules, and a need for a “judge” to decide when they apply. Accordingly, three major components of a policy system include policy rules, which are typically stored in a policy database, policy enforcement, which may be implemented at Policy Enforcement Points (PEP), and Policy Decision Points. The IETF has standardized a protocol for information exchange between PEP's and Policy Decision Points under the term Common Open Policy Service (COPS). In general, a policy may be regarded as a collection of rules that result in one or more actions when specific conditions exist.

Session level policy controls, such as the service-based local policy control described in commonly-assigned U.S. patent application Ser. No. 09/861,817, entitled “Application Influenced Policy,” cannot automatically be applied to PDP contexts unless the relationship of the various media streams to the PDP context is known. That is because such relationships are under the control of the end user establishing the multimedia session, the various media streams, and the corresponding quality of service parameters associated with those media streams.

A chief problem addressed by this invention is how to communicate effectively and efficiently the relationship between a session, media flows in that session, and PDP context bearers established for those media flows in order to request, reserve, supply, and enforce the resources necessary to support each media flow at the PDP bearer level.

This problem is compounded in end-to-end user sessions where the backbone network uses one protocol, e.g., RSVP, to manage/reserve backbone resources for a session while the mobile terminal/UMTS network uses another protocol, e.g., PDP context information, to interwork with backbone quality of service reservation/management mechanisms. Hence, the interworking and cooperation between such different quality of service reservation/management mechanisms is critical to ensure end-to-end quality of service. To enable interworking between these two QoS domains with different signaling protocols, the interworking node must be able to receive service requests from one domain, and generate the necessary service request to the other domain. The interworking node must obtain the necessary service information for the service request to be generated. Where this information is not provided by the received service request, the interworking node must receive a “key” enabling it to access the additional required information from another source.

The present invention overcomes these and other problems by providing an efficient and effective mechanism for binding packet access/bearers in the UMTS to the multimedia streams in a session they support to permit session level control of those bearers, e.g., requesting, reserving, supplying, and enforcing IP level resources needed to support the session. This mechanism also enhances the interaction between UMTS packet access bearers and quality of service reservation and management mechanisms employed by the IP backbone network. IP-level elements in a PDP context activation/modification message include binding information to link each of plural media PDP contexts/data streams to a multimedia session and to a corresponding packet access bearer. As a result, network operators can then identify the multimedia session and apply policy control to each of the media PDP contexts/media streams/packet access bearers in the session. One desirable policy control approach is service-based local policy control described, for example, in commonly-assigned U.S. patent application Ser. No. 09/861,817 entitled “Application Influenced Policy,” filed on May 21, 2001.

In general, the present invention provides a method for use in setting up and orchestrating a multimedia session involving a mobile terminal. A session packet access bearer is established between the mobile terminal and an access point to a packet data network by way of a radio access network. The access point is coupled to a multimedia system that provides multimedia session services. Using the session packet access bearer, the mobile terminal initiates a multimedia session that includes a plurality of media data streams. Media packet access bearers between the mobile terminal and the access point are established. Media binding information is used to associate that multimedia session and each media data stream to one of the media packet access bearers used to transport a corresponding one of the media data streams between the mobile terminal and the access point.

In another example, several media data streams share the same media packet access bearer. A media data stream may be defined as the data flow generated by one single transcoding device or type, or by the aggregate of data flows generated by several transcoding devices or types. In this case, the media binding information elements for several media data streams are all associated with the shared media packet access bearer.

The media binding information may be associated with quality of service information for the corresponding media data stream requested by the user application initiating the session. In one example embodiment, quality of service and media binding information may be included in signaling used to set up the packet access bearers so that policies are applied to each packet access bearer to enforce the quality of service requested for each media data stream in the session.

The absence or presence of the media binding information in a packet access bearer setup message is useful in determining whether a packet access bearer is a general packet access bearer or a multimedia session packet access bearer. In the general case, (i.e., absence of media binding information), basic packet data network IP connectivity services may be employed. In the latter case, (i.e., presence of media binding information), enhanced packet data network-based services such as service-based local policy may be employed using the media binding information.

The media binding information may be used to authorize permissible quality of service for each of the packet access bearers and to obtain both session-related and media data stream-related rules to apply to each packet access bearer. Such rules may relate to admission and policy control for each of the media data streams in the session. Moreover, the session-related data may be used to identify one or more nodes and one or more networks involved in transporting one of the media data streams along a path between the access point through the packet data network to the remote user. If one of the media data stream-related demands on the packet access bearer is modified, the media binding information is also modified, and a new set of policy rules is obtained. Moreover, if the packet access bearer is modified on request by the UE, the current rules are checked to determine if the change is allowed, and if not, updated rules are obtained.

In a preferred, non-limiting, example embodiment, the present invention is adapted to a multimedia session in which a user employs a GPRS/UMTS network to access the packet data network, e.g., the Internet, to establish a multimedia session with a remote host. A session signaling PDP context is established between the mobile terminal in a GPRS network using a corresponding session signaling GPRS bearer. The GPRS network is coupled to a radio access network and to a multimedia system that provides multimedia session services. A multimedia session is initiated between the mobile terminal and the remote host over the session signaling GPRS bearer in cooperation with a call service control server in the multimedia system. Media binding information is created which associates each media data stream to the multimedia session. The mobile terminal forwards the media binding information in a PDP context activation or modification message for each of the media data streams to bind each of the media PDP contexts/GPRS bearers to a corresponding one of the media data streams in the multimedia session.

The GGSN in the GPRS network receives such PDP context messages and uses the media binding information to facilitate interworking to other packet networks connected to the GPRS network and to assist in reserving IP level quality of service resources for each media data stream from the GGSN to the remote host. The quality of service resources for each media data stream from the GGSN to the remote host may be reserved using an Internet-based resource reservation protocol such as RSVP or differentiated services (DiffServ). Quality of service resources for each media data stream in the multimedia session are reserved from the mobile terminal to the GGSN using PDP context messages. In particular, the GGSN uses the media binding information to access a policy controller in the multimedia system and to obtain therefrom quality of service and IP policy enforcement information for each media data stream in the session.

If the IP level resources from the GGSN to the remote host are reserved using RSVP, the GGSN may function as an RSVP proxy for the mobile terminal using session related data to formulate RSVP bearer requests for each media data stream in the session. In a preferred embodiment, the PDP context request message includes the media binding information as a PDP configuration option (PCO). The messages that include the PCO carrying the media binding information are well known GPRS messages for activation/creation of a secondary PDP context or for modification/update of a PDP context.

### BRIEF DESCRIPTION OF THE DRAWINGS

The foregoing and other objects, features, and advantages of the present invention may be more readily understood with reference to the following description taken in conjunction with the accompanying drawings.

FIG. 1 is a block diagram of a high level IP network;

FIG. 2 is a block diagram depicting an example of a network employing end-to-end integrated services;

FIG. 3 is a block diagram depicting an example of a network employing an RSVP proxy;

FIG. 4 is a block diagram depicting an example of a network employing end-to-end differentiated services;

FIG. 5 is a block diagram depicting an example of a network employing RSVP signaling interworking with differentiated services;

FIG. 6 is a block diagram depicting a mobile access data network modeled as a DiffServ network;

FIG. 7 is a block diagram of a UMTS quality of service architecture;

FIG. 8 is a block diagram depicting quality of service management for UMTS bearer services in the control plane;

FIG. 9 is a block diagram depicting quality of service management functions for UMTS bearer services in the user plane;

FIG. 10 is a table of UMTS quality of services classes;

FIG. 11 is a table of quality of service attributes;

FIG. 12 is a table providing an overview of some uses for the quality of service attributes illustrated in FIG. 11;

FIG. 13 is a block diagram of the relationship between PDP address, PDP context, and TFT;

FIG. 14 is a table of valid combinations of TFT packet filter attributes;

FIG. 15 is a diagram of PDP context message exchanges;

FIG. 16 is a block diagram of the quality of service management functions for UMTS bearer services in the control plane and quality of service management functions for end-to-end IP quality of service;

FIG. 17 illustrates a communications system in which a multimedia session may be established between a mobile terminal and a remote host;

FIG. 18 illustrates in flowchart form procedures for media binding in accordance with an example embodiment of the present invention;

FIG. 19 illustrates in more detail a multimedia session in the communications system shown in FIG. 17;

FIG. 20 illustrates in block format various functions performed by the mobile terminal, packet data network access point, and multimedia system;

FIG. 21 illustrates a GPRS/UMTS-based communication system for conducting multimedia sessions in accordance with another example embodiment of the present invention;

FIG. 22 is a flowchart illustrating example procedures for establishing a multimedia session in the system shown in FIG. 21; and

FIG. 23 is a signaling diagram illustrating various signals for establishing a multimedia session in accordance with one example, non-limiting embodiment of the present invention as applied to the system shown in FIG. 21.

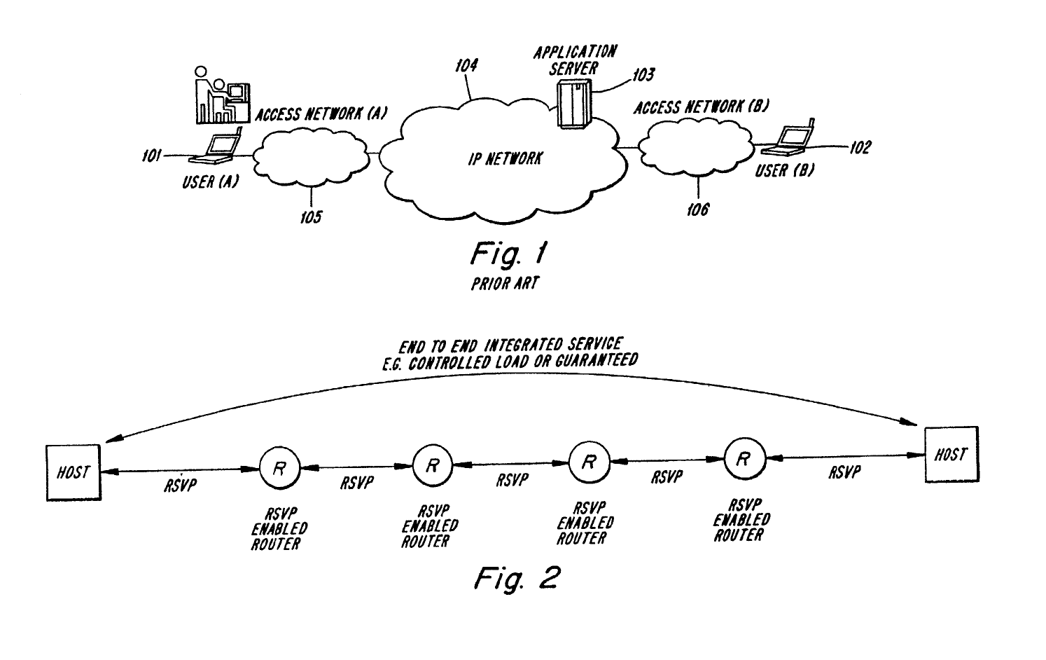

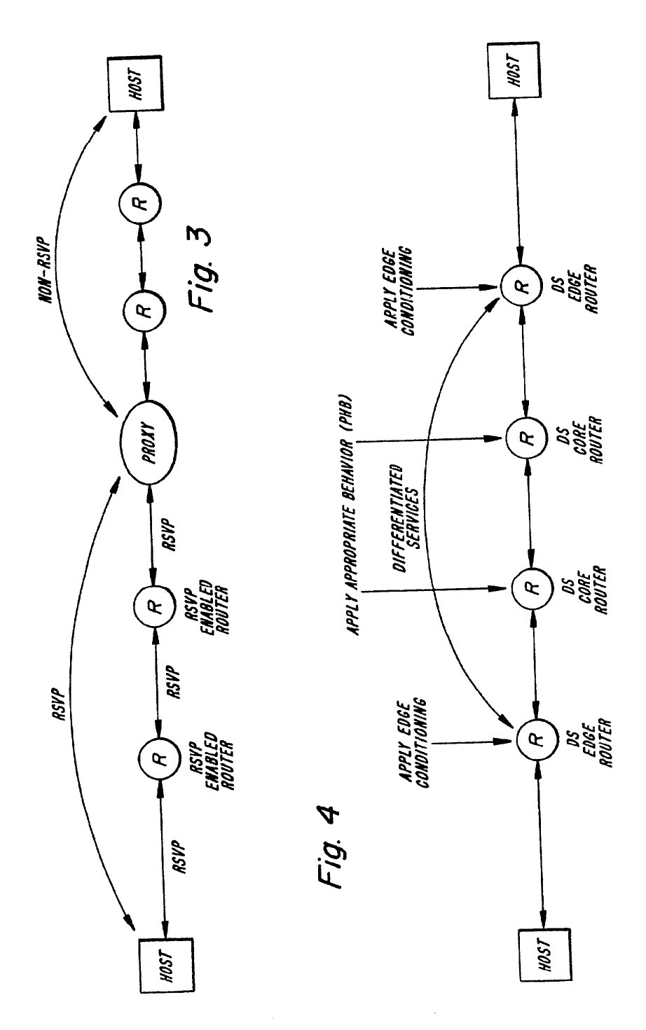

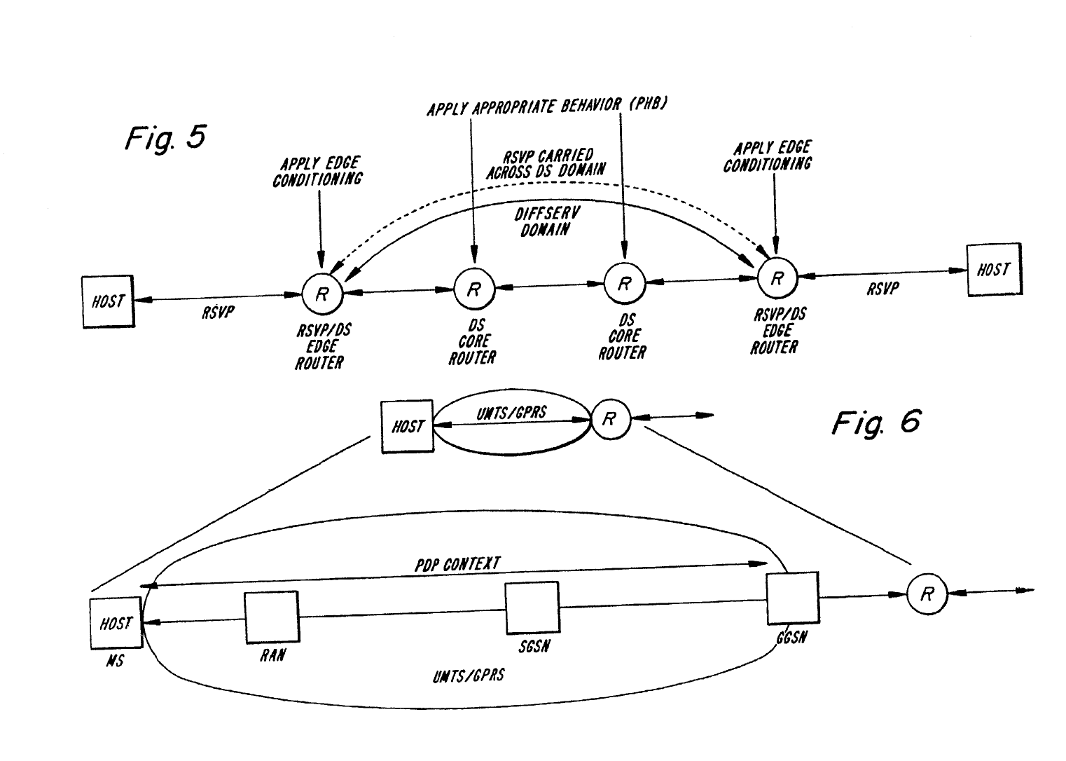

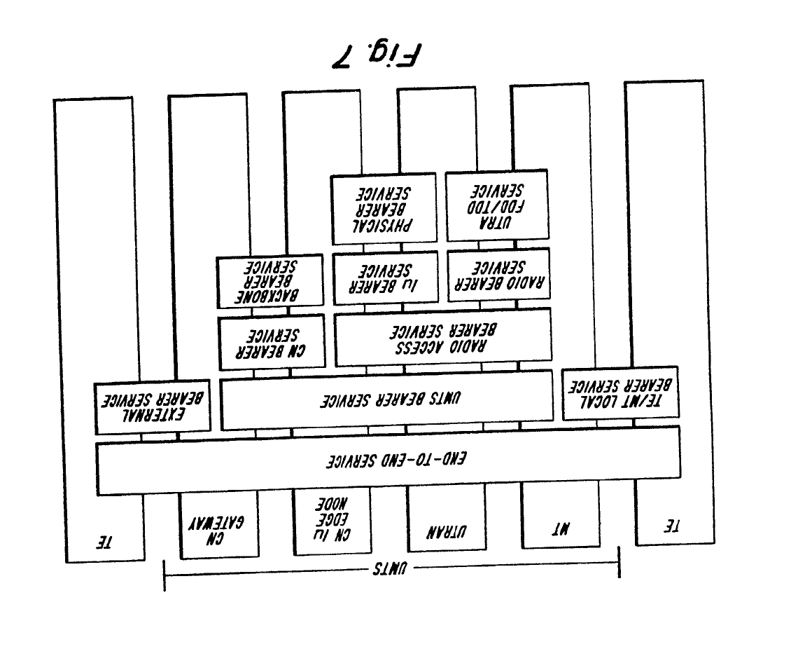

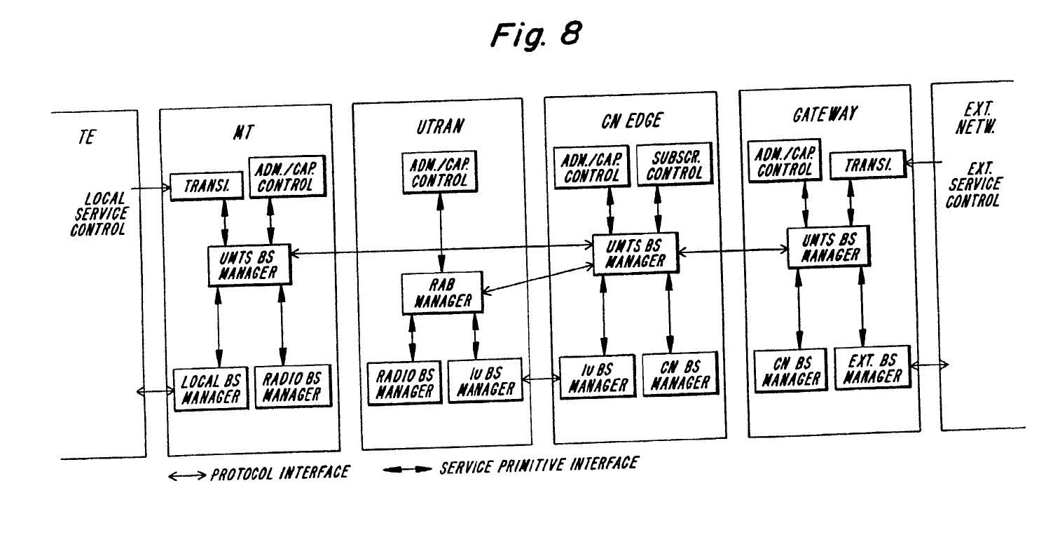

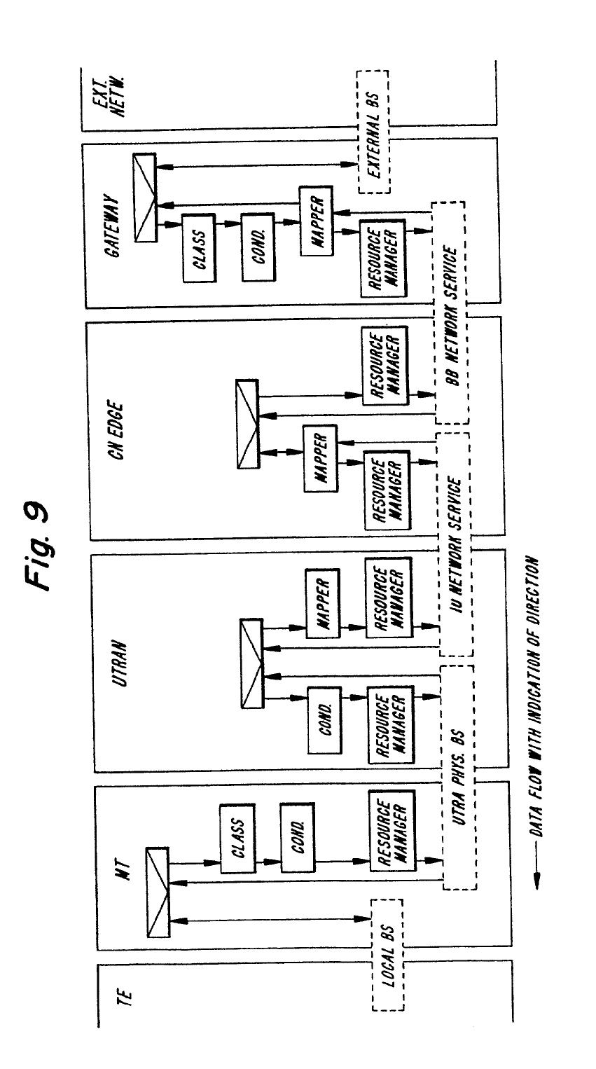

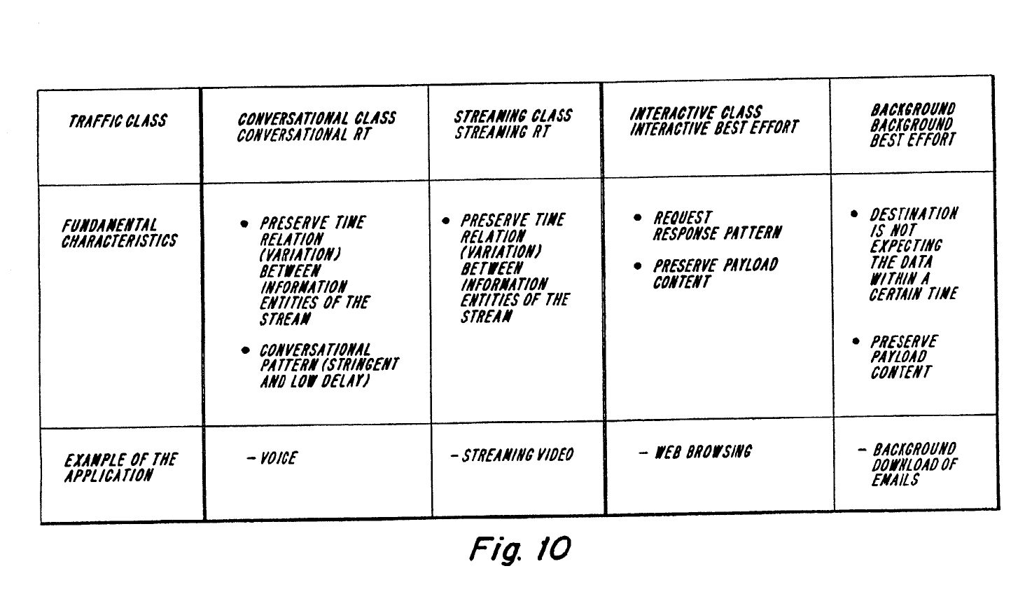

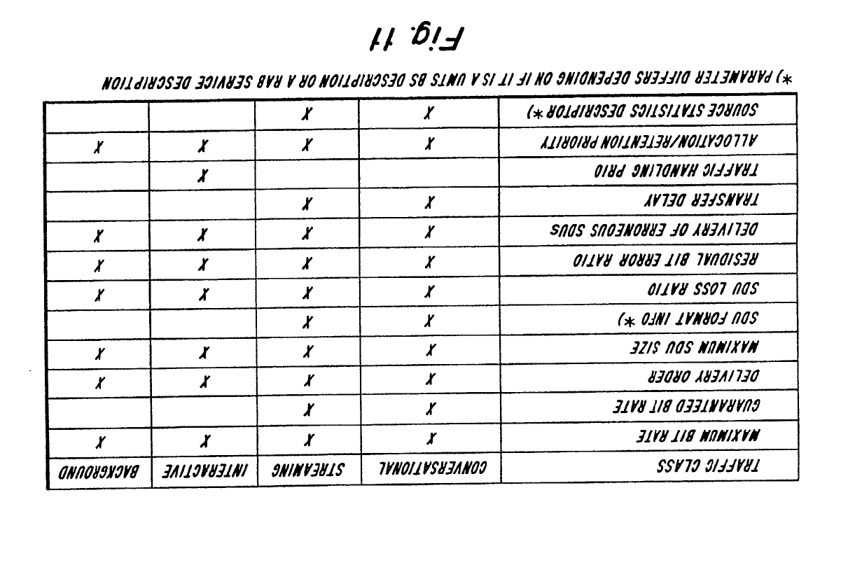

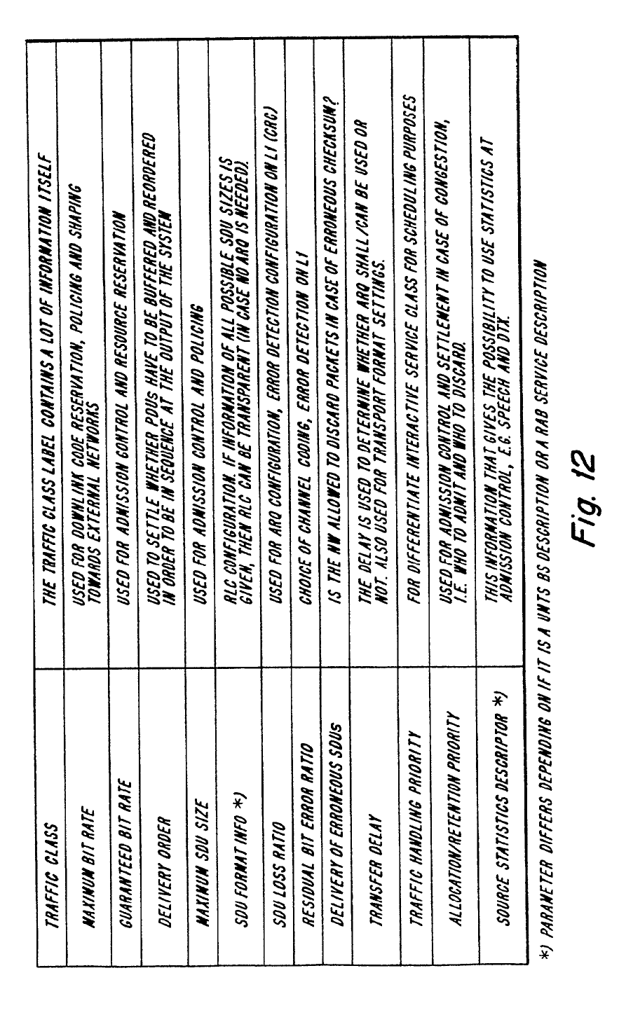

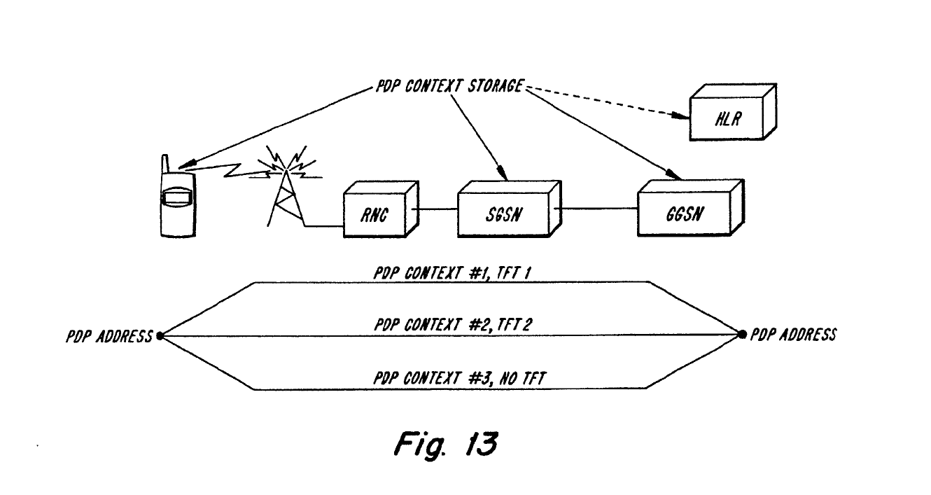

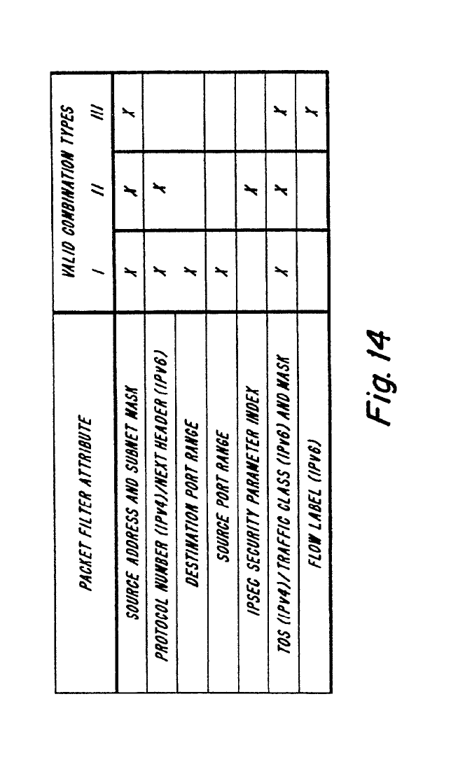

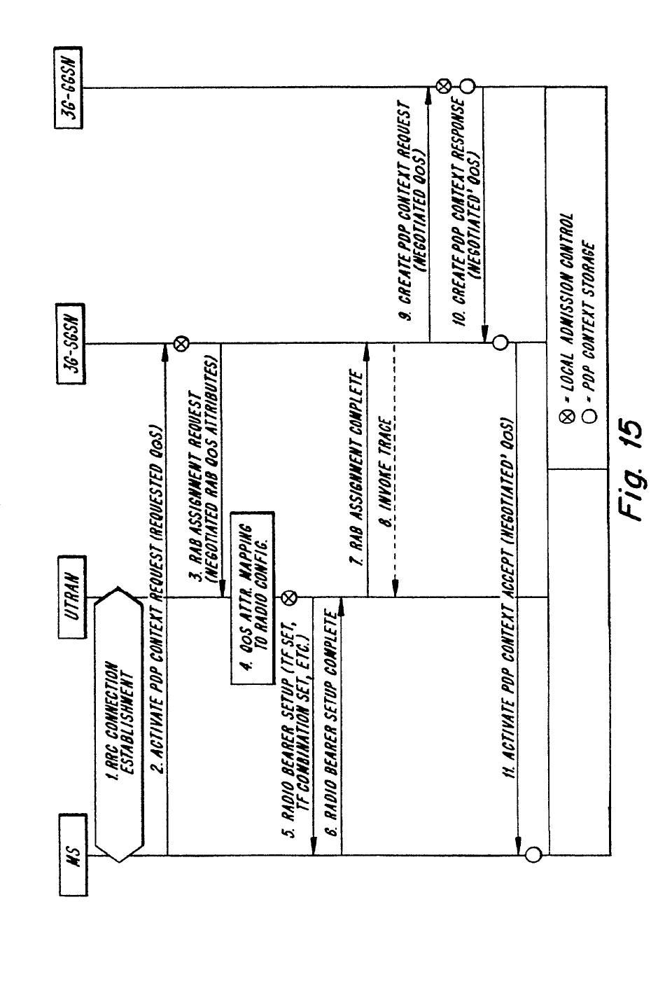

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details. For example, while the present invention is described in an example application to the GSM/UMTS system, the present invention may be employed in any access network system.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

In the following description, a mobile terminal is used as one example of a user equipment (UE) allowing a user access to network services. In a mobile radio communications system, the interface between the user equipment and the network is the radio interface. Thus, although the present invention is described using the term “mobile terminal,” the present invention may be applied to any type or configuration of user equipment that can communicate over a radio interface.

As explained above, to provide IP quality of service end-to-end from mobile terminal to a remote host, it is necessary to manage the quality of service within each domain in the end-to-end path where each domain corresponds to a set of nodes utilizing the same QoS mechanisms. An IP bearer service manager may be used to control the external IP bearer service through the external packet data network, e.g., the Internet, to the remote host. However, there must be a way to interwork resources owned or controlled by the UMTS network and resources in the external packet data network. This is particularly important for multimedia-type communications between a mobile terminal and remote host.

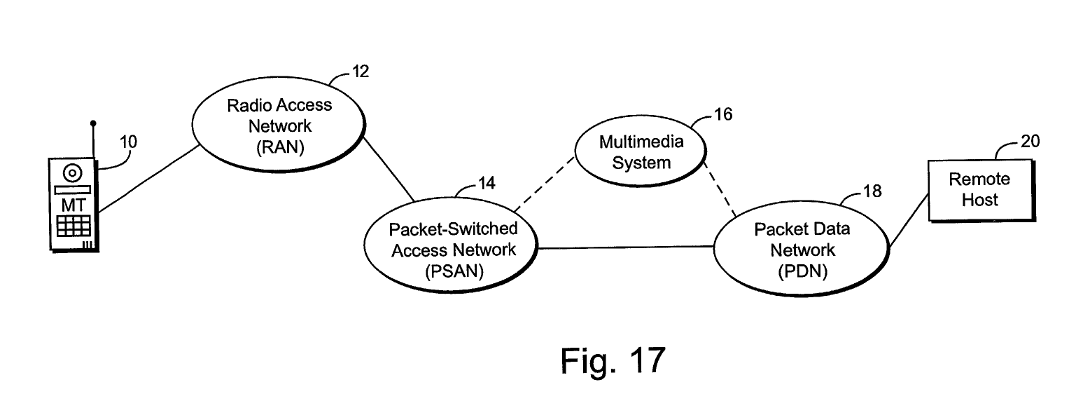

Consider the example, simplified communications system shown in FIG. 17 which permits a Mobile Terminal (MT) 10 to initiate and conduct a multimedia session with a remote host 20. The remote host 20 can be a fixed or wireless device. The mobile terminal 10 is coupled to a radio access network (RAN) 12 over the radio interface. The RAN 12 is coupled to an Access Point in a packet-switched access network (PSAN) 14, which in turn is coupled to a Packet Data Network (PDN) 18 to which the remote host 20 is coupled. The basic traffic flow for a multimedia session (shown as solid lines) between the mobile terminal 10 and remote host 20 is transported via these three networks 12, 14, and 18. The PSAN 14 and the PDN 18 communicate multimedia control signaling (shown as dashed lines) to a Multimedia System 16 that can be separate from or an integral part of the Packet Data Network 18.

In addition to quality of service interworking, it is desirable to provide a mechanism to support service-based local policy enforcement on individual multimedia flows in the session. The present invention provides an effective and efficient way to provide end-to-end IP quality of service and to manage that quality of service within each domain in the end-to-end path in a multimedia session using media binding information. This media binding information permits interworking of resources owned or controlled by the UMTS network with resources in the external packet data network. Furthermore, the media binding information provides a mechanism to support service-based policy enforcement on individual multimedia flows in the session.

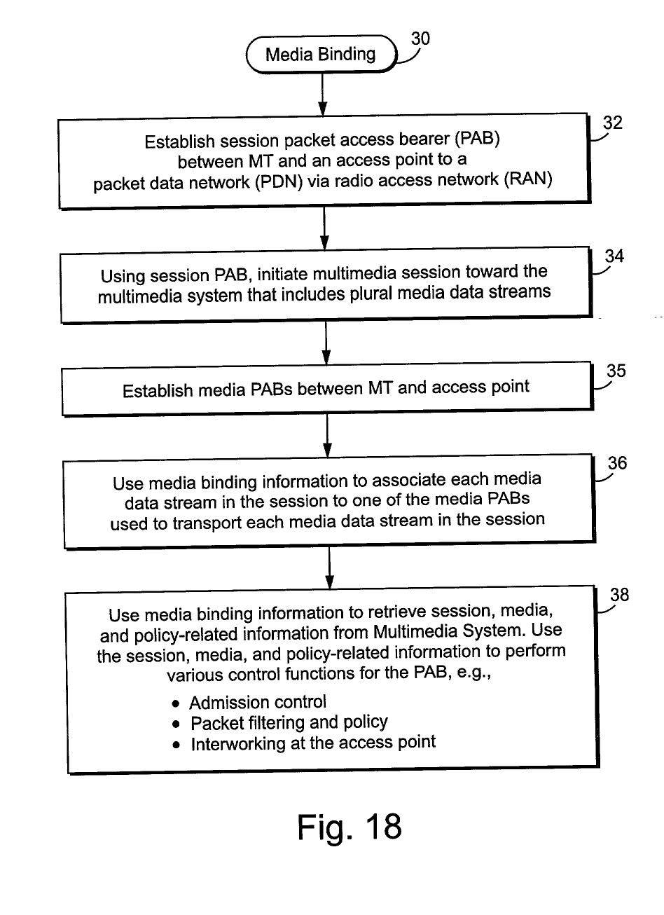

Reference is now made to a media binding (block 30) set of procedures shown in flowchart form in FIG. 18. Initially, a session packet access bearer (PAB) between the mobile terminal 10 and the access point 14 to the packet data network (PDN) 18 via the radio access network (RAN) 12 (block 32). Using the session packet access bearer, the mobile terminal initiates toward the multimedia system a multimedia session with the remote host 20 that includes plural media data streams (block 34). Media packet access bearers corresponding to each of the plural media data streams are established between the mobile terminal 10 and the access point 14 (block 35). Media binding information is used to associate each media data stream in the session to one of the media access bearers used to transport each media data stream in the session (block 36). In addition, the media binding information is used to retrieve session, media, and policy-related information from the multimedia system, which in turn is used to perform various control functions for the packet access bearer. Example functions include admission control, packeting filtering and policing, and interworking at the access point (block 38).

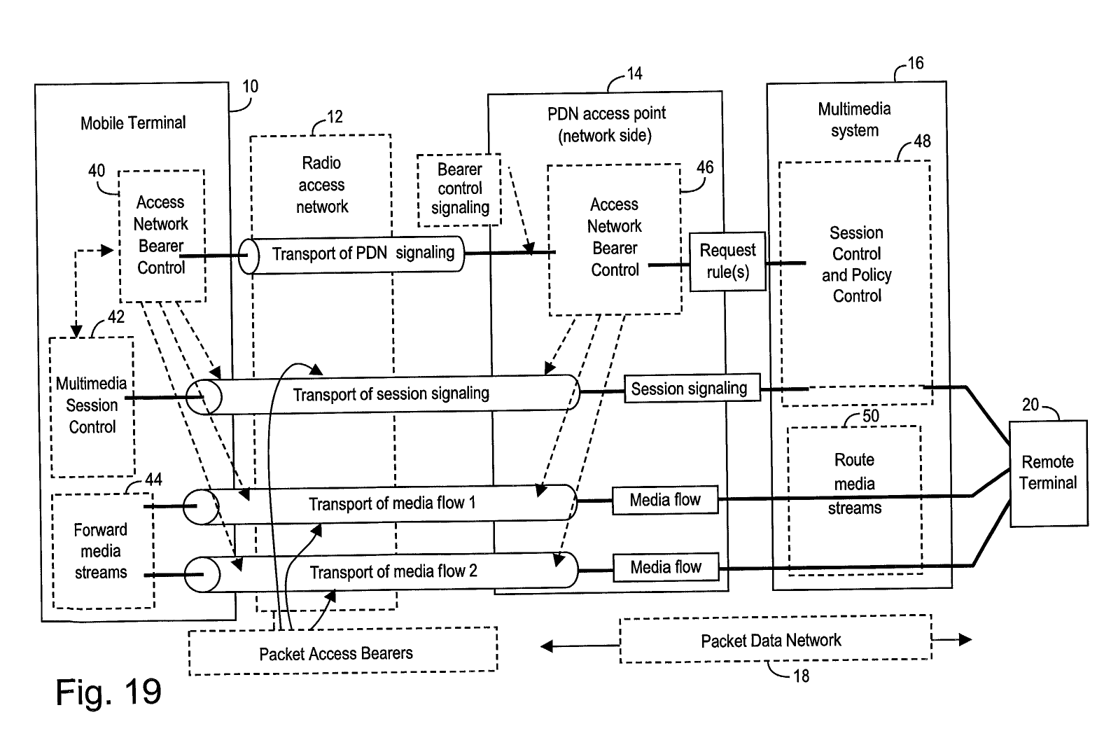

FIG. 19 illustrates, in a functional block diagram format, elements involved in setting up a multimedia session. The mobile terminal 10 includes Access Network Bearer Control 40 coupled to multimedia session control 42. The Access Network Bearer Control block 40 transports internal bearer control signaling, which is not dedicated to a particular session, to an Access Network Bearer Control block 46 in the packet data network access point 14 transparently over the radio access network over a PDN signaling transport bearer. Both Access Network Bearer Control blocks 40 and 46 assist in establishing a packet access bearer for setting up the session shown as the pipe entitled “transport of session signaling.” Over this bearer, the mobile terminal 10 initiates a multimedia session including a plurality of media data streams with the remote terminal 20. Each media data stream or “flow” is transported over a corresponding packet access bearer illustrated as a “transport of media flow” pipe coupled to a Forward Media Streams block 44 in the mobile terminal. Two media flows 1 and 2 are shown for purposes of illustration in this multimedia session. The multimedia system 16 in the packet data network 18 employs a Route Media Streams block 50 to route the packets in each media flow between the mobile terminal 10 and the remote terminal/host 20. Multimedia system 16 also includes a Session Control and Policy Control block 48 that utilizes the session signaling from the Multimedia Session Control block 42 in the mobile terminal 10 to correlate each multimedia flow and its corresponding quality of service requirements with the session to establish necessary admission and policy enforcement rules for the session. Those rules are provided upon request to the Access Network Bearer Control block 46 which performs admission and policy enforcement operations for the session in accordance with the obtained session rules.

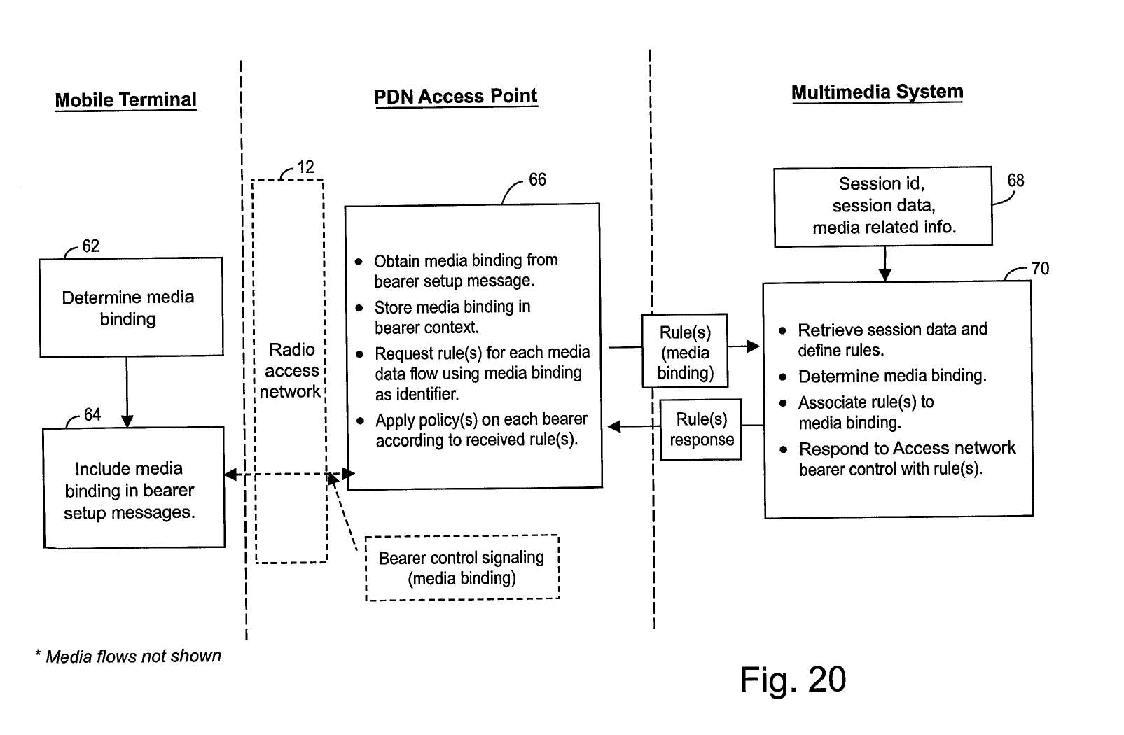

FIG. 20 is a block diagram that provides additional details of the control functions and signaling generally illustrated in FIG. 19. To simplify the illustration and discussion, the media flows are not shown in FIG. 20. The mobile terminal determines media binding information specific to each media flow in the session (block 62). Commonly-assigned, co-pending application entitled “Method and Apparatus for Generating Media Binding Information for Use in a Multimedia Session,” filed on Nov. 5, 2001, the disclosure of which is incorporated herein by reference, describes some examples of how media binding information may be generated or provided.

The media binding information is included in packet access bearer setup signaling for each media flow packet access bearer established for the session between the mobile terminal 10 and the access point 14. See the bearer control signaling block in dashed lines containing the media binding information for each media flow. As illustrated in block 66 at the PDN access point, the media binding information for each flow is obtained from corresponding bearer setup messages.

The media binding information is stored in the PDN access point as a part of the packet access bearer context characterizing the packet access bearer. In addition, the access point requests from the multimedia system rule(s) for each packet access bearer using the media binding information as an identifier. The multimedia system has stored the session identifier, session-related data, and media-related information for the requested session (block 68). Using the session-related data and media-related information, the multimedia system defines appropriate rules for each media flow and thus also for each packet access bearer in the session (block 70). In response to the session rules being requested for each media flow/packet access bearer using the media binding as an identifier from the access point, the multimedia system retrieves the rules using the media binding information as a “key” and provides them to the packet data network access point in a rule(s) response message. The access point performs policy enforcement mechanisms such as one or more filters on each media data flow according to the received rules.

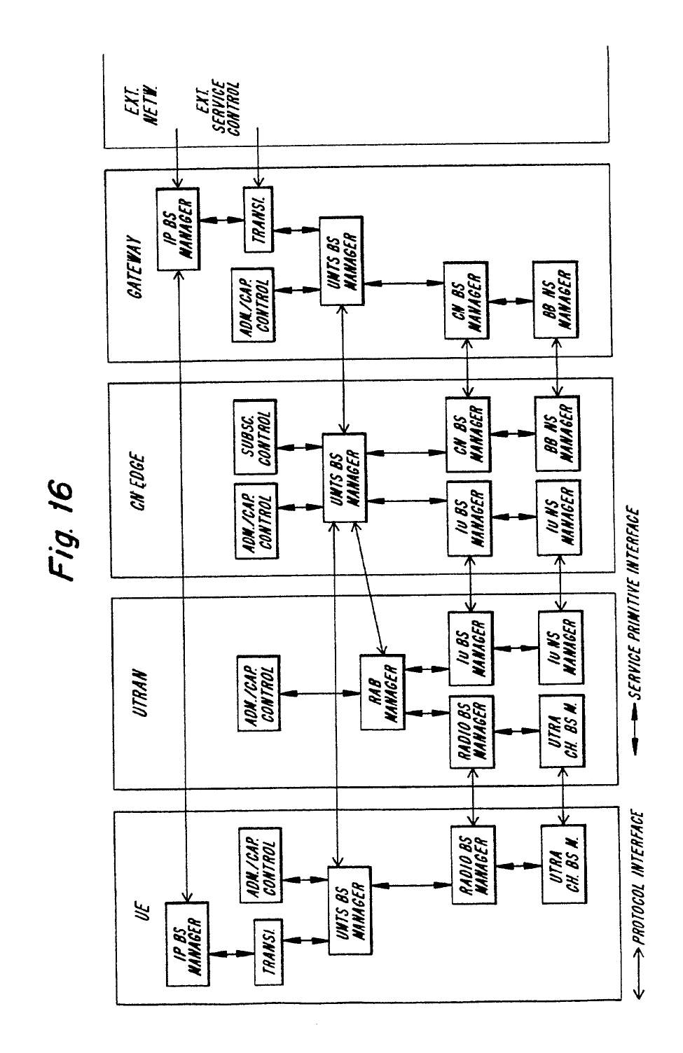

Recall from FIG. 16 that to enable interworking between the UMTS/GPRS and external domains that employ different signaling protocols, the interworking node must be able to receive service requests from one domain, and generate the necessary service request to the other domain. The interworking entity in FIG. 16 is the IP BS manager, and it must obtain the service information needed for the service requests to be generated. Information that is not available in the received service request from one domain may be obtained from a Policy Decision Point coupled to the multimedia service, e.g., by using a key. The Policy Decision Point is provided with session-specific and media-specific information from the multimedia system. The IP BS manager receives an identifier for this information in the UMTS/GPRS bearer request message. With this identifier, the IP BS manager may request additional information needed from the Policy Decision Point in order to perform interworking and generate the service requests toward the external domain.

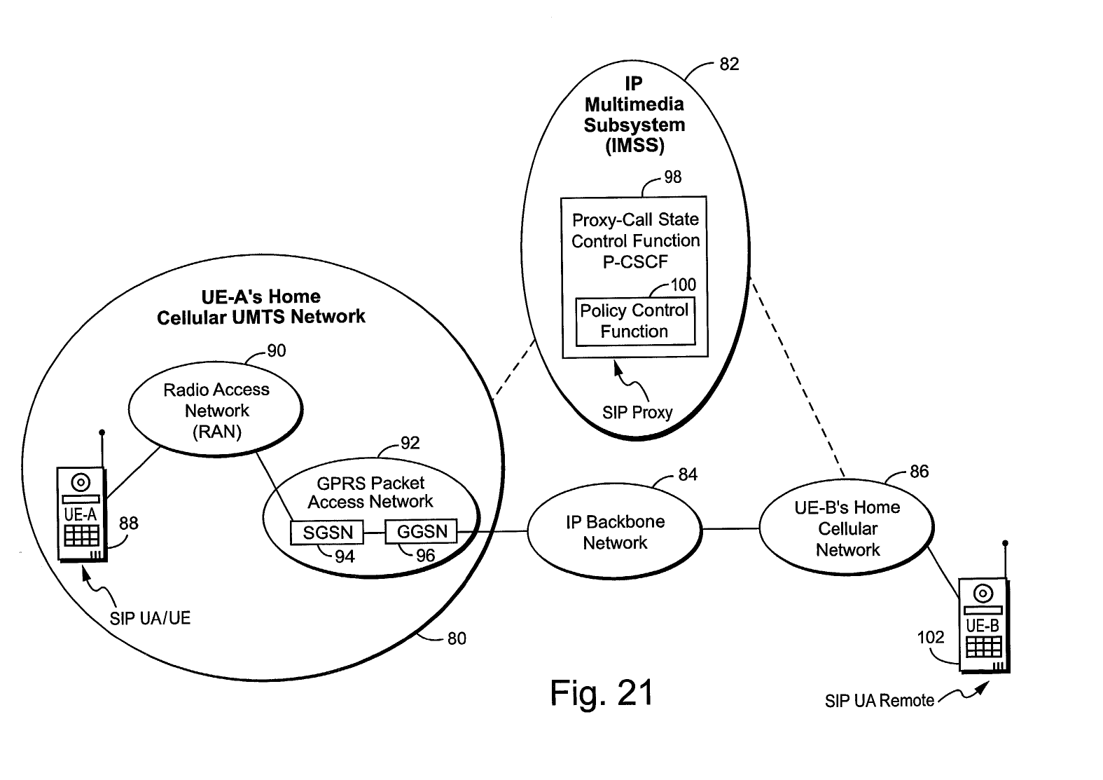

The present invention has particularly advantageous application to multimedia sessions involving a GPRS/UMTS network. Of course, the present invention is not limited to this particular application or to the preferred example embodiment now described. Reference is made to the communications system shown in FIG. 21 that includes a RAN 90 coupled to a GPRS Packet Access Network 92 in a GPRS/UMTS-type network 80 which is coupled to an IP multimedia subsystem (IMSS) 82. Communication with the IMSS 82 (shown as dashed lines) permits exchange of multimedia session control related messages. The GPRS/UMTS-type network 80 is also coupled to an IP backbone network 84. This coupling (shown as a solid line) is used to transport user data IP packets. The IMSS 82 is typically a part of (although it may be separate from and coupled to) an IP backbone network 84. The remote host corresponding to user equipment (UE-B) 102 is coupled to the IP backbone network 84 through its home cellular network 86, and by signaling connection, to the IMSS 82.

In this example, the mobile terminal 88 corresponding to UE-A 88 desires to establish a multimedia session with UE-B 102. The packet traffic for this session follows the solid line couplings between the various nodes. The session is established and managed using Session Initiation Protocol (SIP), and therefore, the user equipments 88 and 102 correspond to SIP User Agents (SIP UA). UE-A 88 is coupled via the Radio Access Network (RAN) 90 to the GPRS packet access network 92. As described earlier, the GPRS network 92 includes one or more SGSNs 94 coupled to one or more GGSNs 96. The IP multimedia system 82 includes a Call State Control Function, in this example a proxy-CSCF (P-CSCF) 98 is shown, and a Policy Control Function (PCF) 100. P-CSCF 98 and PCF 100 may be implemented on the same or different servers. The Proxy-Call State Control Function 98 functions as a SIP proxy for the SIP user agent UE-A 88.

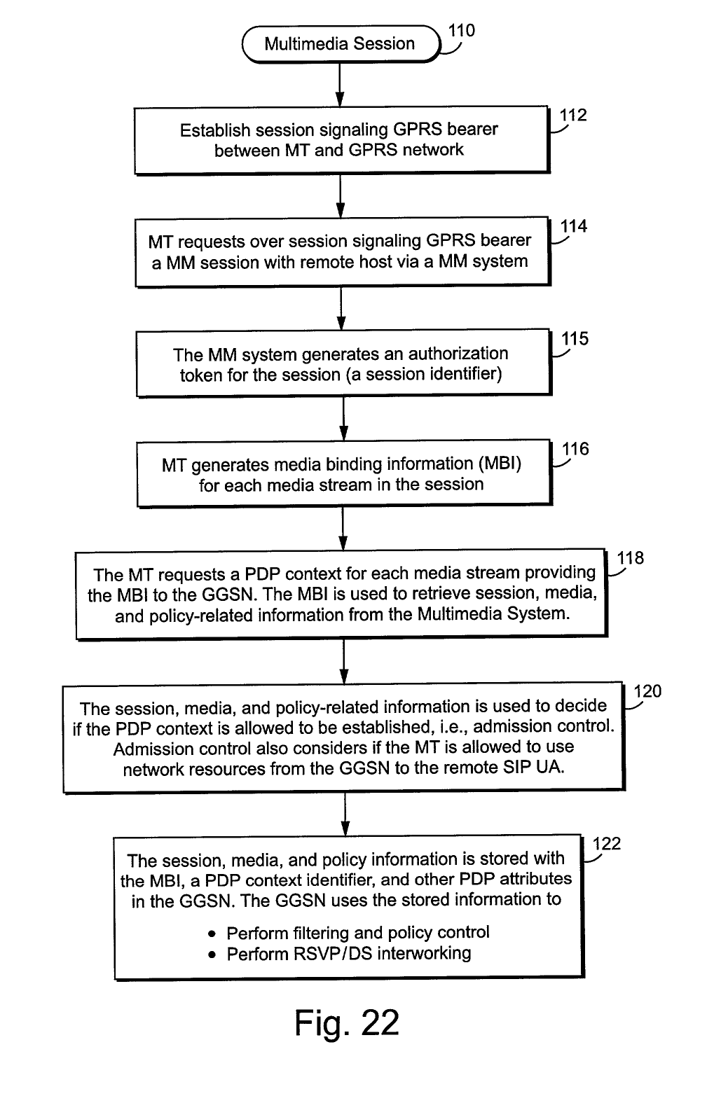

Reference is now made to the Multimedia Session routine (block 110) in FIG. 22 which outlines in flowchart form example procedures for establishing a multimedia session between UE-A and UE-B. A session signaling GPRS bearer is established between UE-A and the GPRS network 92 using well-established GPRS PDP context activation messages. This session signaling GPRS bearer corresponds to a first PDP context signaling (block 112). UE-A requests a multimedia session with the SIP UA remote UE-B over the session signaling GPRS bearer via the RAN 90, the GPRS network 92, the IP multimedia subsystem 82, the IP backbone network 84, and UE-B's home cellular network 86 (block 114). This request may be in the form of an SIP/SDP message which contains sufficient information about the session, such as the source (UE-A) and destination (UE-B) end points, bandwidth requirements, and the characteristics of the media exchange, etc. to trigger an authorization of QoS resources procedure in the Proxy-Call State Control Function 98. The Policy Control Function 100 authorizes, if appropriate, the required quality of service resources for the session and installs an IP bearer level policy for the session and each media flow based on the information from the Proxy-Call State Control Function 98. In addition, the Policy Control Function 100 generates an authorization “token” for the session (session identifier) and sends it to UE-A and UE-B (block 115). The multimedia session is authorized, and the policy control function 100 stores session information for each of the media flows in the session.

In this example, the mobile terminal generates media binding information (MBI) for each media data stream in the session (block 116). The mobile terminal requests a PDP context for each media stream and also provides the MBI to the GGSN in the PDP context request message. The MBI is used to retrieve session, media, and policy related information from the multimedia system (block 118). One MBI may be included per PDP context, or multiple MBIs may be included per PDP context. The MBI may also be used in a PDP context modification message. Because a first PDP context activation message was initially generated to set up the session control signaling GPRS bearer from the mobile terminal UE-A to the GGSN, the PDP context request in block 118 is called a “secondary” PDP context request. The session, media, and policy related information is used to decide if the PDP context is allowed to be established (admission control). The admission control also considers if the mobile terminal is allowed to use network resources from the GGSN to the remote SIP UA (block 120).

The media binding information associates the PDP context bearer with the policy information for that media stream. In a preferred example embodiment, the PDP configuration options parameter present in the existing GPRS PDP context activation/modification message format may be used to carry the media binding information for each PDP context corresponding to one of the media flows. The media binding information includes sufficient information to identify its corresponding media flow and GPRS bearer as well as the session. The media binding information is used by the UE-A, GGSN 96, and the PCF 100 to uniquely identify, monitor, and control the IP media flows and bearers from the session level.

The media binding information (MB) for each of the media data streams is included in the corresponding secondary PDP context request using well-established GPRS-PDP context messaging signals. Again, it is possible to include one MBI per PDP context, or multiple MBIs per PDP context. The GGSN uses the MBIs to pull policy decisions from the PCF. More specifically, the session, media, and policy related information is stored together with the MBI, PDP context identifier, and other PDP context attributes in the GGSN. Based on that stored information and the policy decisions pulled from the PCF, the GGSN performs filtering, policy control, and RSVP/DS interworking (block 122).

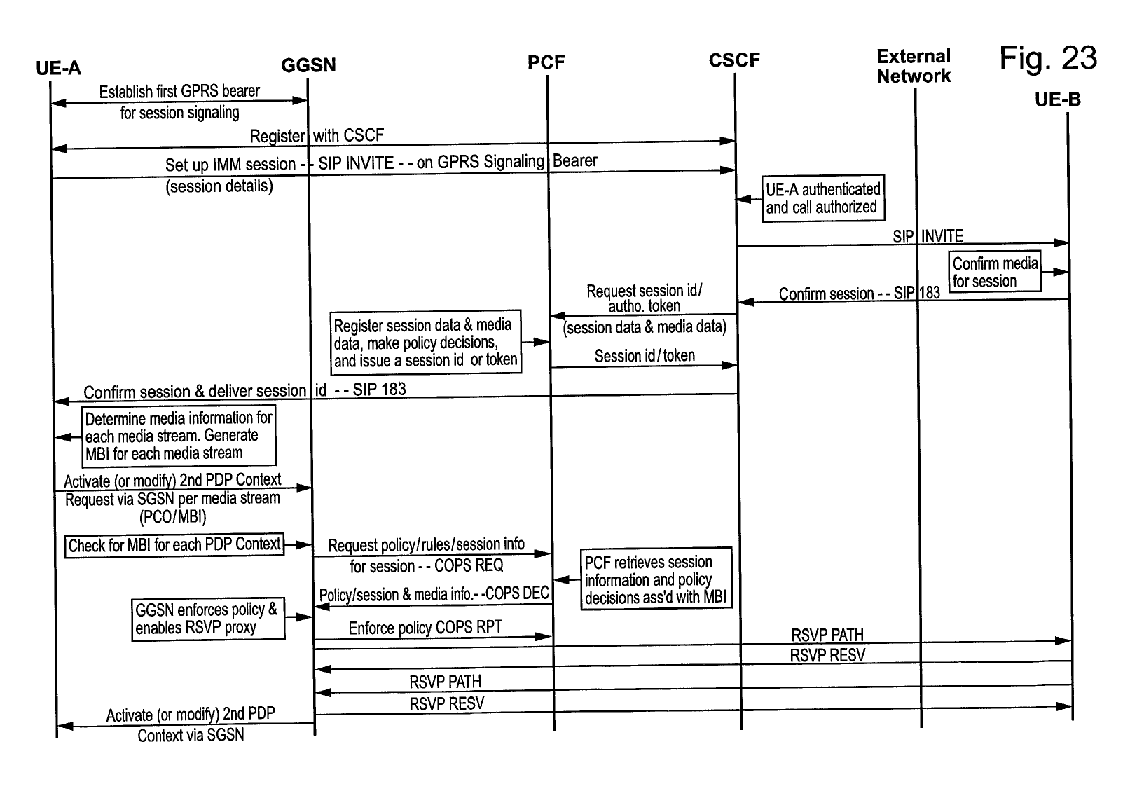

An example signaling flow diagram for an example multimedia session between UE-A and UE-B is shown in FIG. 23 and now described. Initially, the UE establishes a first PDP context with the GGSN to establish a GPRS bearer for session signaling needed to establish the multimedia session. The UE-A then registers with the proxy-CSCF before sending a SIP INVITE message on the GPRS signaling bearer to the CSCF to setup the IP multimedia session. The INVITE message includes the session details regarding the number of media flows and requested corresponding quality of service. The CSCF authenticates the UE-A as a subscriber and authorizes the session. The SIP INVITE message is forwarded to UE-B via external networks. UE-B confirms the session request in a SIP “183” message returned to the CSCF. The SIP 183 is an acknowledgement message to the SIP INVITE message. The CSCF requests from the PCF a session identifier (ID) for the session and communicates session-related and media-related data to the PCF. The session ID corresponds to the authentication token in block 116 in FIG. 22. The PCF registers the session-related data and the media-related data, makes policy decisions for the session, issues the session ID (authorization token), and returns it to the CSCF. The CSCF confirms the session, and delivers the session ID in a SIP 183 message to the UE-A.

The UE-A determines media information from each media stream, and generates media binding information (MBI) for each media stream using the session ID and the media information. Alternatively, the UE-A may receive the MBI from the CSCF in the SIP 183 message or from another entity. Still further, the UE-A may create the MBI using some other procedure that does not employ the session ID. The UE-A activates a second PDP context (i.e., by sending a secondary PDP context request message to the SGSN) for each media stream. The PDP configuration options (PCO) parameter is an attribute that is part of the well-known GPRS messages for control of GPRS bearers (PDP contexts). A PCO in each secondary PDP context request message preferably includes the media binding information (MBI) for each media stream.

The GGSN uses the MBI as an identifier for each media stream and requests the policy/rules for the session and media stream in a COPS REQ message. In response to this request, the PCF retrieves the session information and policy decisions associated with the MBI for each media stream and returns the policy rules and other session-related and media-related information to the GGSN in a COPS DEC message. Using the obtained rules and information, the GGSN enforces the policy and acknowledges the request for each secondary PDP context. The GGSN responds with a COPS RPT message.

Policy control allows the network operator to control the authorization and usage of GPRS bearers based on the session attributes. For example, the network operator may apply policies such as:

Authorizing a particular type of GPRS bearer (a high bandwidth real time GPRS bearer), only for a media stream with relevant characteristics (e.g., a high quality video conference)

Restricting the bandwidth of the PDP context dependent on a selected codec signaled to be used in the session

Blocking and enabling transmission of the media stream based on the state of the SIP Session, blocking the GPRS bearer before a session thru state, i.e., not enabling the GPRS bearer until the session thru message has passed the P-CSCF.

The GGSN may also use the session-related and media-related information, (e.g., the UE-B address), to enable itself as an RSVP proxy for the UE-A, generating and terminating RSVP signaling for each media stream to/from UE-B. As an RSVP proxy, the GGSN generates an RSVP PATH message for each media data stream to UE-B, which is then confirmed by an RSVP RESV message from the UE-B. This is done for the establishment of the RSVP flow from the GGSN to the UE-B. The GGSN RSVP proxy responds to each RSVP PATH message from UE-B with a RSVP RESV message. This is done for the establishment of the RSVP flow from the UE-B to the GGSN. The two RSVP Flows are established for each bidirectional media data stream for which GGSN has established the RSVP proxy function. Furthermore, the GGSN may use the obtained rules and session/media-related information to perform admission control. For example, the address of UE-B may be used to identify which external network and nodes the media stream shall pass through, and to determine if admission is allowed to these nodes/networks.

Although RSVP is shown in this signaling diagram, other external network resource reservation protocols may be used, e.g., DiffServ. The GGSN uses the obtained rules and session/media-related information to reserve and establish a corresponding transport path with the requested QoS through the external packet data network to the UE-B. The necessary interworking between the GPRS/UMTS bearer and the IP transport through the external packet data network for a certain media stream is supported by contexts stored in the GGSN containing the MBI, and for example, the obtained rules and session/media-related information, attributes and status information for the GPRS bearer, and attributes and status information associated with RSVP.

Thus, irrespective of the quality of service mechanism used by the external packet data network, the media binding information may be used to enhance interworking options/functionality at the GGSN, for example, to obtain the necessary parameters for RSVP signaling, which it does not receive in the PDP context signaling, and thus provide interworking to the RSVP enabled domains. Other examples of enhanced interworking using the MBI include performing more complex admission control decisions by obtaining, for example, the destination IP address, providing access to resources reserved for traffic accessing a specific IP multimedia service by obtaining multimedia session-related event triggers, using the obtained destination address to select an external packet data network quality of service mechanism or interface, and applying additional traffic controls for the bearer, (e.g., restrictive source/destination address and port numbers), defined based on the multimedia application that is using the bearer.

While the present invention has been described with respect to particular embodiments, those skilled in the art will recognize that the present invention is not limited to these specific exemplary embodiments. Different formats, embodiments, and adaptations besides those shown and described as well as many variations, modifications, and equivalent arrangements may also be used to implement the invention. Therefore, while the present invention has been described in relation to its preferred embodiments, it is to be understood that this disclosure is only illustrative and exemplary of the present invention. Accordingly, it is intended that the invention be limited only by the scope of the claims appended hereto.

What is claimed is:

1. A method for use in setting up a multimedia session involving a mobile terminal and an access point to a packet data network by way of a radio access network, the access point being coupled to a multimedia system that provides multimedia session services, comprising:
initiating a multimedia session involving the mobile terminal that includes a plurality of media data streams;
establishing a plurality of media packet access bearers between the mobile terminal and the access point; and
using media binding information to associate each media data stream in the session to a corresponding media packet access bearers, each of the media packet access bearers transporting its corresponding media data stream between the mobile terminal and the access point.

2. The method in claim 1, wherein the media binding information enables individual control at a session level of each media packet access bearer in the multimedia session.

3. The method in claim 1, wherein multiple media data streams share a same media packet access bearer and multiple media binding information elements corresponding to each of the multiple media data streams are associated with the shared media packet access bearer.

4. The method in claim 1, wherein the media binding information for each media data stream is associated with quality of service information for the corresponding media data stream, and wherein the quality of service may be different for each one of the media data streams in the multimedia session.

5. The method of claim 1, further comprising:
using the absence of media binding information in a packet access bearer setup message to determine that a packet access bearer is a general packet access bearer, and
using the presence of media binding information in a packet access bearer message to determine that a packet access bearer is associated with a specific media stream in a multimedia session.

6. The method in claim 1, further comprising:
using the media binding information to authorize permissible quality of service for each one of the packet access bearers transporting the media data streams in the multimedia session,
wherein the quality of service may be different for each one of the packet access bearers.

7. The method in claim 1, further comprising:
using the media binding information to identify the session and each media data stream in the session; and
obtaining session-related rules to apply to each packet access bearer transporting a corresponding one of the media data streams; and
obtaining media data stream-related rules to apply to each packet access bearer transporting a corresponding one of the media data streams.

8. The method in claim 7, further comprising:
using one or more of the obtained rules to apply one or more filters for traffic received over each packet access bearer transporting the media data streams.

9. The method in claim 1, further comprising:
using the media binding information to identify the session and obtain session-related data, and
using the session-related data to reserve quality of service (QoS) resources for each of the media data streams in the session between the access point and a remote user over the packet data network.

10. The method in claim 1, further comprising:
using the media binding information to identify the session and obtain session-related data, and using the session-related data to identify one or more nodes and one or more networks involved in transporting one of the media data streams along a path between the access point through the packet data network to the remote user; and
determining if resources are available to support a quality of service request for the one media data stream along the path;
if the requested resources are available for the one media data stream, admitting the one media data stream to use the packet data network along the path; and
if the requested resources are not available, rejecting use of the requested resources for the one media data stream.

11. The method in claim 1, wherein if one of the media data streams in the multimedia session is modified, modifying the media binding information associating each media data stream to a corresponding one of the media packet access bearers.

12. The method in claim 1, wherein if one of the media packet access bearers is modified, using the media binding information to authorize permissible quality of service for the modified media packet access bearer transporting one of the media data streams in the multimedia session.

13. A method for use in setting up a multimedia session involving a mobile terminal capable of communicating with a General Packet Radio Service (GPRS) network, the GPRS network being coupled to a radio access network and to a multimedia system that provides multimedia session services, comprising:
the mobile terminal requesting a multimedia session with a remote host using the multimedia system, the multimedia session including a plurality of media data streams;
generating media binding information for each of the plurality of media data streams;
requesting a media GPRS bearer for each media data stream and associating the media binding information to each media GPRS bearer; and
transporting the media data streams using corresponding ones of the media GPRS bearers.

14. The method in claim 13, wherein multiple media data streams share a same media GPRS bearer and multiple media binding information elements corresponding to each of the multiple media data steams are associated with the shared media GPRS bearer.

15. The method in claim 13, wherein the mobile terminal provides the media binding information to a GPRS Gateway Support Node (GGSN) in a signaling message associated with a corresponding GPRS bearer, and the GGSN uses the media binding information to facilitate interworking to one or more packet data networks coupled to the GPRS network.

16. The method in claim 15, wherein the GGSN uses the media binding information to identify the session and to obtain session-related data.

17. The method in claim 16, wherein the GGSN uses the session-related data to reserve Internet Protocol (IP) level resources for each of the media data streams in the session from the GGSN to the remote host.

18. The method in claim 17, wherein the IP level resources from the GGSN to the remote host are reserved using a resource reservation protocol (RSVP), and wherein the GGSN functions as an RSVP proxy for the mobile terminal using the session-related data to formulate RSVP bearer requests for each media data stream in the session.

19. The method in claim 17, wherein the multimedia system includes a call service control server which provides session information to a policy controller associated with the call service control server, and wherein the policy controller establishes policies for the session.

20. The method in claim 15, wherein a requested media GPRS bearer is established as a new media GPRS bearer or by modifying an already-established media GPRS bearer.

21. The method in claim 20, wherein a message to request a media GPRS bearer includes an activate secondary PDP context request message and a create PDP context request message, each of these PDP context request messages including the media binding information as a PDP configuration option (PCO).

22. The method in claim 20, wherein a message to request a media GPRS bearer includes a modify PDP context request message and an update PDP context request message, each of these PDP context request messages including the media binding information as a PDP configuration option (PCO).

23. The method in claim 15, further comprising:
the GGSN detecting in a request message the media binding information, and in response, requesting policy information related to the session from the policy controller using the media binding information.

24. The method in claim 23, further comprising:
the policy controller returning to the GGSN the policy information related to the session using the media binding information.

25. The method in claim 24, further comprising:
the GGSN enforcing the policy established by the policy information using the media binding information.

26. The method in claim 25, wherein the GGSN functions as a resource reservation protocol (RSVP) proxy for the mobile terminal to reserve resources for the session between the GGSN and the remote host using the media binding information.

27. The method in claim 21, further comprising:
confirming establishment of a PDP context for each media stream in the session between the GGSN and the mobile terminal.

28. The method in claim 21, further comprising:
the GGSN using the media binding information to authorize permissible parameters associated with each one of the GPRS bearers defined by its corresponding PDP context to transport one of the media data streams in the multimedia session.

29. The method in claim 21, further comprising:
the GGSN using the session related data to perform admission control for each one of the GPRS bearers defined by its corresponding PDP context to transport one of the media streams in the multimedia session.

30. The method in claim 13, wherein if one of the media data streams in the multimedia session is modified, modifying the media binding information associating that media data stream to a corresponding one of the GPRS bearer.

31. The method in claim 13, wherein if one of the GPRS bearers is modified, using the associated media binding information to identify the session and to obtain modified session-related data to be applied to the modified GPRS bearer transporting one of the media data streams in the multimedia session.

32. The method of claim 15, further comprising:
the GGSN using the absence of media binding information in the signaling message associated with a particular GPRS bearer to determine that the GPRS bearer is a general GPRS bearer not associated with a multimedia session or the presence of media binding information in the signaling message associated with a particular GPRS bearer to determine that a PDP context is associated with one of the media data streams of a multimedia session.

33. The method in claim 15, wherein the GGSN uses the session information to enhance interworking between protocols used between the GGSN and the mobile terminal and the GGSN and the remote host.

34. A method for use in establishing a multimedia session involving a mobile terminal capable of communicating with a General Packet Radio Service (GPRS) network, the GPRS network being coupled to a radio access network and to a multimedia system that provides multimedia session services, comprising:
initiating a multimedia session between the mobile terminal and a remote host using a call service control server in the multimedia system, the multimedia session including a plurality of media data streams;
generating media binding information associating each one of the media data streams to the multimedia session; and
forwarding the media binding information in a PDP context activation or modification message for each of the media data streams to bind each of the media PDP contexts to a corresponding one of the media data streams in the multimedia session.

35. The method in claim 34, wherein a GPRS Gateway Support Node (GGSN) uses the media binding information to assist in reserving quality of service resources for each media data stream from the GGSN to the remote host.

36. The method in claim 35, wherein quality of service for each media data stream in the session from the mobile terminal to the GGSN are reserved using the PDP context messages and quality of service resources for each media data stream from the GGSN to the remote host are reserved using an Internet-based protocol.

37. The method in claim 36, wherein the Internet-based protocol is the resource reservation protocol (RSVP).

38. The method in claim 36, wherein the Internet-based protocol is the Differentiated Services (DiffServ) protocol.

39. The method in claim 35, wherein the GGSN uses the media binding information to support policy enforcement.

40. The method in claim 35, wherein the GGSN uses the media binding information to access a policy controller in the multimedia system and obtain from the policy controller quality of service and policy enforcement information for each media data stream in the session.

41. A mobile terminal comprising electronic circuitry capable of communicating with an access point to a packet data network by way of a radio access network, the access point being coupled to a multimedia system that provides multimedia session services, the mobile terminal being configured to perform the following tasks:
initiate a multimedia session that includes a plurality of media data streams;
assist in establishing a plurality of media packet access bearers to the access point for transporting corresponding ones of the media data streams between the mobile terminal and the access point; and
use media binding information to associate each media data stream in the session to one of the media packet access bearers.

42. The mobile terminal in claim 41, wherein the media binding information for each media data stream is associated with quality of service information for the corresponding media data stream, and wherein the quality of service may be different for each one of the media data streams in the multimedia session.

43. The mobile terminal in claim 42, wherein the quality of service information and media binding information are included in signaling used to set up the session.

44. The mobile terminal in claim 41, wherein the electronic circuitry is further configured to include the media binding information in one or more a PDP context activation, creation, modification, or update request message to the access point, each of the messages including the media binding information as a PDP configuration option (PCO).

45. The mobile terminal in claim 44, wherein the PDP context activation message is an activate PDP context request message or an activate secondary PDP context request message.

46. The mobile terminal in claim 44, wherein a media binding field in the PCO has a variable length.

47. The mobile terminal in claim 44, wherein the PDP context creation message is a create PDP context request message.

48. The mobile terminal in claim 44, wherein the PDP context modification message is a modify PDP context request message.

49. The mobile terminal in claim 44, wherein the PDP context update message is an update PDP context request message.

50. A computer generated data signal embodied in an electrical signal for use in a GPRS/UMTS network comprising:
a PDP context activation, creation, modification, or update message for establishing or updating a multimedia session between a mobile terminal and a remote host, the PDP context activation, creation, modification, or update message having plural fields of information including a PDP configuration options (PCO) field that includes media binding information associating each media data stream in the multimedia session with a GPRS data packet bearer.

51. The computer generated data signal in claim 50, wherein the media binding field in the PCO for storing the media binding information has a variable length.

52. The computer generated data signal in claim 50, wherein the PDP context activation message is an activate secondary PDP context request message.

53. The computer generated data signal in claim 50, wherein the PDP context activation message is an activate PDP context request message.

54. A packet data network access point coupled to a radio access network and a multimedia system for providing services in a multimedia session between a mobile terminal and a remote host comprising electronic circuitry configured to perform the following tasks:
in response to a multimedia session request from the mobile terminal, assist in establishing a multimedia session with a plurality of media data streams including establishing a plurality of media packet access bearers between the mobile terminal and the access point, where the media packet access bearers transport corresponding ones of the media data streams between the mobile terminal and the access point, and
use media binding information to associate each media data stream in the session to one of the media packet access bearers.

55. The access point in claim 54, wherein the electronic circuitry is configured to assist in setting up and enforcing quality of service for each packet access bearer using the media binding information.

56. The access point in claim 54, wherein the electronic circuitry is configured to detect the absence of media binding information in a packet access bearer setup message to determine that a packet access bearer is a general packet access bearer, and to detect the presence of media binding information in a packet access bearer message to determine that a packet data bearer is associated with a multimedia session.

57. The access point in claim 56, wherein the electronic circuitry is configured to use the media binding information to identify the session and each media data stream in the session and to obtain rules to apply to each packet access bearer transporting a corresponding one of the media data streams.

58. The access point in claim 57, wherein the rules include session-related rules and media data stream-related rules.

59. The access point in claim 57, wherein the electronic circuitry is configured to use one or more of the obtained rules to apply one or more filters for the traffic received over each packet access bearer transporting the media data streams.

60. The access point in claim 54, wherein the electronic circuitry is configured to use the media binding information to obtain information related to the multimedia session and each media data stream and use the obtained information to reserve quality of service (QoS) resources for each of the media data streams in the session between the access point to the packet data network and a remote user.

61. The access point in claim 60, wherein the electronic circuitry is configured to use the obtained information to identify one or more nodes and one or more networks involved in transporting one of the media data streams along a path between the access point through the packet data network to the remote user and to determine if resources are available to support a quality of service request for the one media data stream along the path,
wherein if the requested resources are available for the one media data stream, the one media data stream is admitted to use the packet data network along the path, and if the requested resources are not available, use of the requested resources for the one media data stream is rejected.

62. The access point in claim 60, wherein the access point is a GPRS Gateway Support Node (GGSN) in a GPRS network, the GGSN being configured to use the media binding information to facilitate interworking to one or more packet data networks coupled to the GPRS network.

63. The access point in claim 62, wherein the GGSN is configured to use the media binding information to identify the session and to obtain session-related data.

64. The access point in claim 63, wherein the GGSN is configured to use the session-related data to reserve Internet Protocol (IP) level resources for each of the media data streams in the session from the GGSN to the remote host.

65. The access point in claim 64, wherein the IP level resources from the GGSN to the remote host are reserved using a resource reservation protocol (RSVP), and wherein the GGSN is configured to function as an RSVP proxy for the mobile terminal using the session-related data to formulate RSVP bearer requests for each media data stream in the session.

66. The access point in claim 62, wherein the GGSN is configured to detect media binding information in a PDP context request or modification message, and in response, to request from a policy controller policy information related to the session using the media binding information.

67. The access point in claim 66, wherein the GGSN is configured to receive policy information related to the session by the media binding information and to enforce the policy using the media binding information.

68. The access point in claim 62, wherein the GGSN is configured to use the absence of media binding information in the signaling message associated with a particular GPRS bearer to determine that the GPRS bearer is a general GPRS bearer not to be associated with a multimedia session or the presence of media binding information in the signaling message associated with a particular GPRS bearer to determine that a PDP context is associated with one of the media data streams of the multimedia session.

69. The access point in claim 68, wherein the GGSN is configured to use the media binding information to authorize permissible parameters associated with each one of the GPRS bearers defined by its corresponding PDP context to transport one of the media data streams in the multimedia session.

70. The access point in claim 62, wherein the GGSN is configured to use the session related data to perform admission control for each one of the GPRS bearers using the media binding information.

71. The access point in claim 62, wherein the GGSN is configured to enhance interworking between protocols used between the GGSN and the mobile terminal and between the GGSN and the remote host using the media binding information.

72. The access point in claim 62, wherein the GGSN is configured to receive a request from the multimedia system that the GGSN function as a resource reservation protocol proxy on behalf of the mobile terminal for the session, and wherein the GGSN is configured to act as the requested resource reservation protocol proxy for the session.

73. The access point in claim 62 wherein the multimedia system generates the media binding information from a session identifier and a media portion of a session setup message and uses the media binding information to communication with the GGSN for the session.

74. The access point in claim 54, wherein the electronic circuitry is configured to individually control at a session level each GPRS bearer in the multimedia session.
